(19) United States
(12) Patent Application Publication
(10) Pub. No.: US 2025/0002764 A1
(43) Pub. Date: Jan. 2, 2025

(54) Hot Melt Adhesives Comprising Lao-Derived Diluents

(71) Applicant: ExxonMobil Technology and Engineering Company, Annandale, NJ (US)

(72) Inventors: Jennifer J. Austin, The Woodlands, TX (US); Madelyn Bekker, Houston, TX (US); Pilanda Watkins-Curry, Cove, TX (US); Jurgen Jan Martha Schroeyers, Opvelp (BE); Clement Arinal, Le Havre (FR)

(73) Assignee: ExxonMobil Technology and Engineering Company, Annandale, NJ (US)

(21) Appl. No.: 18/710,495

(22) PCT Filed: Nov. 18, 2022
(86) PCT No.: PCT/US2022/050403

§ 371 Date: May 15, 2024

Related U.S. Application Data
(60) Provisional application No. 63/265,599, filed on Dec. 17, 2021.

(51) Int. Cl. C09J 123/10; C09J 153/02

(52) U.S. Cl. CPC C09J 123/10; C09J 153/02

(57) ABSTRACT

Hot melt adhesives may comprise linear alpha olefins (LAOs) or LAO-derived compounds as an at least partial replacement for paraffinic white oil diluents. Such adhesive compositions may comprise an ethylenically unsaturated polymer or copolymer, a tackifier, and a diluent. The diluent may comprise at least one of: one or more C₁₈₊ linear alpha olefins (LAOs) having a kinematic viscosity of about 4 cSt or less at 135° C.; one or more LAO dimers formed from one or more C₁₈₊ LAOs, the one or more LAO dimers having an internal olefin and a kinematic viscosity of about 6 cSt or less at 135° C., or one or more paraffinic hydrocarbons having an even carbon number distribution and formed through dimerization of one or more C₁₈₊ LAOs and subsequent reduction. The one or more paraffinic hydrocarbons may have a kinematic viscosity (ASTM D-445) of about 4 cSt to about 8 cSt at 135° C.

### CROSS REFERENCE TO RELATED APPLICATIONS

This application is a national stage application, filed under 35 U.S.C. 371, of International Patent Application No. PCT/US2022/050403, filed Nov. 18, 2022, which claims priority to Provisional Application No. 63/265,599, filed Dec. 17, 2021, which are incorporated by reference in its entirety.

### FIELD

The present disclosure relates to hot melt adhesives and, more particularly, hot melt adhesives formulated to exhibit decreased viscosity values.

### BACKGROUND

Hot melt adhesives (HMAs) are thermoplastic polymer compositions that may be applied to a substrate in a molten state and then placed in contact with one or more additional substrates to promote adherence between the two. Upon cooling and solidifying, optionally with crystallization occurring during solidification, the hot melt adhesive forms an adhesive bond between the two substrates. Prolonged set times, poor peel strength (adhesive bond strength), and excessive viscosity may be problematic for various industries making use of hot melt adhesives, particularly those employing rapid manufacturing lines.

It may be difficult to balance viscosity with other properties in conventional hot melt adhesives, since viscosity trends to track with other properties. For example, hot melt adhesives having a low viscosity may also exhibit a correspondingly low cohesion strength. Thus, it may be difficult to achieve a balance of set time, bonding strength, and low viscosity sufficient to meet the specific needs of a given application or process.

In addition to the thermoplastic polymer, additives such as plasticizers, tackifiers, and antioxidants, for example, may be introduced into hot melt adhesives to modify one or more properties thereof. Diluents, such as paraffinic white oils, for example, are sometimes introduced into hot melt adhesives to decrease viscosity. While white oil diluents may effectively decrease the viscosity of hot melt adhesives and sometime the glass transition temperature (Tg), the oil may concurrently decrease the adhesive bond strength, modulus, and cohesion. Additionally, oil-based diluents may be undesirable due to their strong odor and their tendency to migrate post-setting, eventually leading to degradation of the adhesive bond strength.

Separately, slow crystallization kinetics may be problematic in some instances, particularly for polypropylene-based hot melt adhesives. Slow crystallization kinetics may result in poor initial set strength, which may preclude applicability of such hot melt adhesives in rapid manufacturing lines. The combination of poor initial set strength and low adhesive bond strength may render a hot melt adhesive unsuitable for particular applications. Conversely, excessive crystallinity of the thermoplastic polymer may also be problematic in certain instances, particularly for applications taking place below the glass transition temperature of the thermoplastic polymer, due to excessive brittleness.

### SUMMARY

In some aspects, the present disclosure provides adhesive compositions comprising: an ethylenically unsaturated polymer or copolymer; a tackifier; and a diluent comprising at least one of: one or more LAO dimers formed from one or more C₁₈₊ LAOs, the one or more LAO dimers having an internal olefin and a kinematic viscosity (ASTM D-445) of about 6 cSt or less at 135° C.; or one or more paraffinic hydrocarbons having an even carbon number distribution and formed through dimerization of one or more C₁₈₊ LAOs and subsequent reduction, the one or more C₁₈₊ LAOs having a kinematic viscosity (ASTM D-445) before dimerization of about 4 cSt or less at 135° C.

In some or other aspects, the present disclosure provides adhesive compositions comprising: about 60 wt. % or above of a polypropylene polymer or copolymer; a tackifier; and a diluent comprising at least one of: one or more C₁₈₊ linear alpha olefins (LAOs) having a kinematic viscosity (ASTM D-445) of about 4 cSt or less at 135° C.; one or more LAO dimers formed from one or more C₁₈₊ LAOs, the one or more LAO dimers having an internal olefin and a kinematic viscosity (ASTM D-445) of about 6 cSt or less at 135° C.; or one or more paraffinic hydrocarbons having an even carbon number distribution and formed through dimerization of one or more C₁₈₊ LAOs and subsequent reduction, the one or more C₁₈₊ LAOs having a kinematic viscosity (ASTM D-445) before dimerization of about 4 cSt or less at 135° C.

In still other aspects, the present disclosure provides adhesive compositions comprising: a styrenic block copolymer; a tackifier; and a diluent comprising at least one of: one or more C₁₈₊ linear alpha olefins (LAOs) having a kinematic viscosity (ASTM D-445) of about 4 cSt or less at 135° C.; one or more LAO dimers formed from one or more C₁₈₊ LAOs, the one or more LAO dimers having an internal olefin and a kinematic viscosity (ASTM D-445) of about 6 cSt or less at 135° C.; or one or more paraffinic hydrocarbons having an even carbon number distribution and formed through dimerization of one or more C₁₈₊ LAOs and subsequent reduction, the one or more C₁₈₊ LAOs having a kinematic viscosity (ASTM D-445) before dimerization of about 4 cSt or less at 135° C.

These and other features and attributes of the disclosed methods and compositions of the present disclosure and their advantageous applications and/or uses will be apparent from the detailed description which follows.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one having ordinary skill in the art and having the benefit of this disclosure.

To assist one of ordinary skill in the relevant art in making and using the subject matter hereof, reference is made to the appended drawings, wherein:

FIG. 1 is a flow diagram of a non-limiting example method for producing a hot melt adhesive of the present disclosure.

FIGS. 2 and 3 are overlay plots of differential scanning calorimetry (DSC) endothermic melting peaks and exothermic crystallization peaks, respectively, for LAO dimers and paraffinic hydrocarbons derived from LAO dimers specified in Table 1.

FIG. 4 is a bar graph showing a comparison of Brookfield viscosity values (ASTM D-3236) at 140° C. for several polyolefin-based hot melt adhesive compositions (Samples 2A-2C, 3B and 4A).

FIG. 5 is a bar graph summarizing T-peel adhesion force performance (ASTM D-903) for Samples 2A, 2C, 2C′, 2B, 3B, and 4A at 30 minutes, 24 hours, 30 days, and following forced aging conditions.

FIG. 6 is a bar graph of Brookfield viscosity (ASTM D-3236) for Samples 8A-8D at various temperatures.

FIGS. 7A-7D are combined DSC plots of endothermic melting peaks and exothermic crystallization peaks for Samples 12-15 (PE-based hot melt adhesives).

FIGS. 8A-8D are combined DSC plots of endothermic melting peaks and exothermic crystallization peaks for Samples 18-21 (EVA-based hot melt adhesives).

FIG. 9 is a plot of complex rheology for Sample 15.

FIG. 10 is a plot of complex rheology for Sample 21.

### DETAILED DESCRIPTION

The present disclosure relates to hot melt adhesives and, more particularly, hot melt adhesives formulated to exhibit decreased viscosity values.

As discussed above, excessive viscosity of hot melt adhesives may limit their use in applications requiring a combination of high adhesive bond strength, rapid and strong initial set strength, and a desired low viscosity. Targeted viscosity values may include those compatible with spray coating or slot coating techniques commonly used in rapid manufacturing lines, such as those used in the hygiene products industry. It may be difficult to balance these properties and others in order to promote suitability for a given application. For example, diluents such as paraffinic white oils and naphthenic oils may effectively decrease viscosity but degrade performance of hot melt adhesives in other aspects, such as peel strength or excessive odor.

The present disclosure provides alternative diluents that may replace or partially replace paraffinic white oils or similar substances in hot melt adhesives to achieve a balance of properties suitable for various applications. In particular, the present disclosure provides various types of LAO-derived diluents that may replace or partially replace paraffinic white oils in hot melt adhesive compositions to afford comparable or superior viscosity performance while also not detrimentally impacting the adhesive bond strength. Some of the LAO-derived diluents, in fact, may surprisingly afford a desirable combination of decreased viscosity and improved peel strength performance in comparison to paraffinic white oils or paraffinic waxes in a similar molecular weight range. In fact, increased adhesion may be surprisingly realized for the LAO-derived diluents in comparison to paraffinic white oils or paraffinic waxes having a higher molecular weight range, as evidenced by comparison of complex modulus (G′) values at their plateau. Suitable LAO-derived diluents may include parent LAOs themselves, dimerized variants of the parent LAOs (LAO dimers) in which an internal olefin forms in the dimer, or paraffinic hydrocarbons obtained from LAO dimers via reduction (reduced dimers). The size (number of carbon atoms) of the LAOs incorporated in such diluents may be varied as well. Depending on the end use application for the hot melt adhesives and the desired properties thereof, suitable LAO-derived diluents may include C₁₈-C₂₄ LAOs (e.g., C₂₀-C₂₄ LAOs) and/or C₂₄. LAOs, and their corresponding LAO dimers and reduced dimers (also referred to herein as paraffinic dimers or paraffinic hydrocarbons). Advantageously, all of these diluents may be readily accessed from an in-common source of LAOs. Properties of the LAOs, LAO dimers, and paraffinic hydrocarbons, and the hot melt adhesives obtained therefrom, are addressed in more detail hereinbelow.

Advantageously, the hot melt adhesives of the present disclosure may be tailored to promote compatibility with continuous processing lines, such as those producing hygiene products (e.g., diapers, adult incontinence products, feminine hygiene products, and the like). Hot melt adhesives containing styrenic block copolymers, such as styrene-butadiene-styrene, styrene-ethylene-butylene-styrene, and styrene-isoprene-styrene, or isotactic polypropylene would be highly suitable for these and other hygiene-type applications were it not for the excessive melt viscosity of these copolymers. At present, tackifiers and oils are used with these and similar polymers to achieve optimal performance in hot melt adhesive applications. Desirably, the LAO-derived diluents disclosed herein may promote a decrease in melt viscosity for these and other polymers while simultaneously maintaining or improving the adhesive bond strength, thereby facilitating their use in hygiene applications. Modification of the viscosity performance of isotactic polypropylene may be especially desirable in this regard, since its supply chain is typically more reliable than that of styrenic block copolymers and residual odor of styrenic block copolymers may sometimes be problematic for hygiene applications. At the least, residual odor may be undesirable from a commercial acceptability standpoint. Such tailoring of the properties of hot melt adhesives may be achieved by selecting a particular LAO-derived diluent (e.g., LAOs in a specified size range, LAO dimers in a specified size range, and/or paraffinic hydrocarbons obtained from LAO dimers in a specified size range) and introducing an effective amount of the LAO-derived diluent to decrease viscosity without negatively impacting the adhesive bonding properties. Advantageously, some LAO-derived diluents may even improve properties such as the peel strength when substituted for paraffinic white oils, again while realizing low viscosity values. Indeed, LAO-derived diluents may outperform paraffinic diluents of higher molecular weight when formulated in hot melt adhesive compositions, thereby facilitating decreased viscosity values at similar loadings of diluent. Blends of LAOs and paraffinic hydrocarbons, such as blends of one or more of the foregoing LAO-derived diluents and a Fischer-Tropsch wax or a paraffinic hydrocarbon wax, may also be used in the disclosure herein. Such paraffinic hydrocarbons obtained by blending may differ in composition from the paraffinic hydrocarbons obtained through hydrogenation of LAO dimers.

Advantageously, the LAO-derived diluents of the present disclosure may be at least partially crystalline solids, which may facilitate their ease of handling. Conventional diluents, in contrast, may be liquids. In addition, the at least partial crystallinity of the LAO-derived diluents may facilitate crystallization of the thermoplastic polymer in hot melt adhesives in some instances, thereby promoting more rapid setting and improving the initial set strength in some cases. As a still further advantage, the LAO-derived diluents described herein may also allow the amount of tackifier to be decreased in some instances and/or the LAO-derived diluents may replace at least a portion of the tackifier in a given hot melt adhesive.

Furthermore, paraffinic hydrocarbons obtained through hydrogenation of LAO dimers may surprisingly promote comparable adhesion performance to paraffinic hydrocarbons having a similar size but without increased viscosity values associated with the latter. For example, paraffinic hydrocarbons obtained from LAO dimers may provide a desirable combination of peel strength and low viscosity in comparison to paraffinic hydrocarbons such as Fischer-Tropsch waxes. Without being bound by theory or mechanism, the even carbon number distribution of LAO dimers and paraffinic hydrocarbons obtained from LAO dimers are believed to promote these improved properties.

All numerical values within the detailed description and the claims herein are modified by “about” or “approximately” with respect to the indicated value, and take into account experimental error and variations that would be expected by a person having ordinary skill in the art.

As used in the present disclosure and claims, the singular article forms “a,” “an,” and “the” include plural forms unless the context clearly dictates otherwise.

The term “and/or” as used in a phrase such as “A and/or B” herein is intended to include “A and B,” “A or B,” “A,” and “B.”

For the purposes of the present disclosure, the new numbering scheme for groups of the Periodic Table is used. In said numbering scheme, the groups (columns) are numbered sequentially from left to right from 1 through 18.

Unless otherwise indicated, room temperature (RT) is about 23° C.

As used herein, the term “hydrocarbon” refers to a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different numbers of carbon atoms. The term “Co” refers to hydrocarbon(s) or a hydrocarbyl group having n carbon atom(s) per molecule or group along the main carbon chain, wherein n is a positive integer. The term “Cₙ₊” refers to hydrocarbon(s) or a hydrocarbon group having n carbon atoms or more per molecule or group along the main carbon chain. The term “Co” refers to hydrocarbon(s) or a hydrocarbon group having n carbon atoms or less per molecule or group along the main carbon chain. Such hydrocarbon or hydrocarbyl groups may be one or more of linear, branched, cyclic, acyclic, saturated, unsaturated, aliphatic, or aromatic.

As used herein, the terms “hydrocarbyl” and “hydrocarbyl group” are used interchangeably herein. The term “hydrocarbyl group” refers to any C₁-C₁₀₀ hydrocarbon group bearing at least one unfilled valence position when removed from a parent compound. “Hydrocarbyl groups” may be optionally substituted, in which the term “optionally substituted” refers to replacement of at least one hydrogen atom or at least one carbon atom with a heteroatom or heteroatom functional group. Hydrocarbyl groups therefore may include alkyl, alkenyl, alkynyl, aryl, heteroaryl, cycloalkyl, heterocyclyl, and the like, any of which may be optionally-substituted.

As used herein, the terms “linear” and “linear hydrocarbon” refer to a hydrocarbon or hydrocarbyl group having a continuous carbon chain without side chain branching.

As used herein, the term “olefin,” alternatively referred to as “alkene,” is a linear, branched, or cyclic compound of carbon and hydrogen having at least one carbon-carbon double bond.

As used herein, the term “alpha olefin” refers to an olefin having a terminal carbon-carbon double bond in the structure thereof (e.g., RHC═CH₂, where R is hydrogen or a hydrocarbyl group).

As used herein, the term “linear alpha olefin (LAO)” refers to an unbranched alkenic hydrocarbon bearing a carbon-carbon double bond at a terminal (end) carbon atom of a continuous carbon chain without side chain branching.

As used herein, the terms “branch,” “branched” and “branched hydrocarbon” refer to a hydrocarbon or hydrocarbyl group having a linear continuous carbon chain in which a hydrocarbyl side chain extends from the linear continuous carbon chain.

As used herein, the term “blend” refers to a mixture of two or more components. Blends may be produced by, for example, solution blending, melt mixing, or compounding in a shear mixer. The terms “blending” and “combining” are used interchangeably herein.

As used herein, the term “Mn” is the number average molecular weight, and Mw is the weight average molecular weight. Unless otherwise noted, all molecular weight units (e.g., Mw, Mn) are expressed in g/mol.

As used herein, the term “copolymer” refers to a polymer containing at least two different monomer units.

As used herein, the term “ethylenically unsaturated polymer” refers to a polymer obtained through polymerization of one or more monomers containing an ethylenic unsaturation. An “ethylenically unsaturated monomer” contains a polymerizable carbon-carbon double bond.

Unless otherwise specified, all viscosity values for LAO-derived diluents are kinematic viscosities measured by ASTM D-445 at 135° C. or 100° C.

Unless otherwise specified, all viscosity values for hot melt adhesives are Brookfield viscosities measured by ASTM D-3236.

Accordingly, hot melt adhesive compositions of the present disclosure may comprise an ethylenically unsaturated polymer or copolymer, a tackifier, and a diluent comprising at least one of: one or more C₁₈₊ LAOs, one or more LAO dimers formed from one or more C₁₈₊ LAOs, or one or more paraffinic hydrocarbons formed through reduction of one or more LAO dimers formed from one of more C₁₈₊ LAOs. Additional description of suitable ethylenically unsaturated polymers, tackifiers, and diluents is provided hereinbelow. Optionally, additional components such as plasticizers, antioxidants, and the like may also be present.

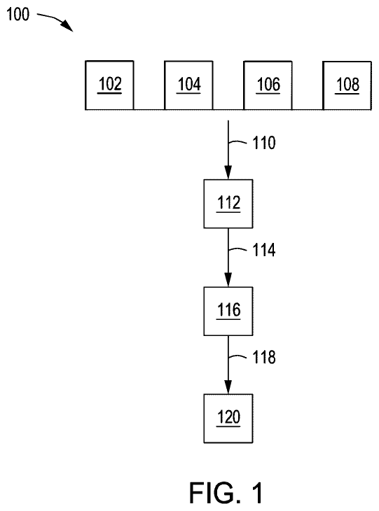

FIG. 1 is a flow diagram of non-limiting example method 100 for producing a hot melt adhesive of the present disclosure. Thermoplastic polymer 102, tackifier 104, and LAO-derived diluent 106 are combined 110 to produce mixture 112. Optionally, additional components 108 may be combined 110 within mixture 112. Thermoplastic polymer 102, tackifier 104, LAO-derived diluent 106, and additional components 108 can be combined 110 in any order, with mixing and/or heating taking place during the process of combining 110.

Mixture 112 is processed 114 by applying shear at or above the melting point or softening temperature of thermoplastic polymer 102 to form molten adhesive blend 116. Molten adhesive blend 116 may then be extruded 118 to an adhesive bond within article 120. Alternately, molten adhesive blend 116 may be processed into a desired shape and cooled, and the hot melt adhesive composition may be re-melted before extrusion.

Compositions of the present disclosure may be prepared by any suitable mixing process. Mixing may be performed by dry blending or extruding a mixture of the various components of the composition, such as by a masterbatch technique. Mixing may also be performed by blending the components using conventional masticating equipment, for example, a rubber mill, Brabender Mixer, Banbury Mixer, Buss-Ko Kneader. Farrel continuous mixer or twin-screw continuous mixer in the melt, such as at a temperature from about 130° C. to about 210° C., until a homogeneous blend is obtained. Mixing temperatures may depend on the particular composition being formed, with about 150° C. to about 160° C. typically being a suitable range. Other embodiments may employ mixing temperatures of about 130° C. to about 160° C., about 130° C. to about 200° C., about 150° C. to about 160° C., or about 150° C. to about 200° C.

Examples of suitable diluents for hot melt adhesives in the disclosure herein may include, but are not limited to, (a) one or more C₁₈₊ linear alpha olefins (LAOs) having a kinematic viscosity (ASTM D-445) of about 4 cSt or less at 135° C.; (b) one or more LAO dimers formed from one or more C₁₈₊ LAOs, the one or more LAO dimers having an internal olefin and a kinematic viscosity (ASTM D-445) of about 6 cSt or less at 135° C., or (c) one or more paraffinic hydrocarbons having an even carbon number distribution and formed through dimerization of one or more C₁₈₊ linear alpha olefins (LAOs) and subsequent reduction, the one or more C₁₈₊ LAOs having a kinematic viscosity (ASTM D-445) before dimerization of about 4 cSt or less at 135° C. The foregoing diluents are described in further detail below.

Ethylenically unsaturated polymers or copolymers suitable for inclusion in the hot melt adhesive compositions disclosed herein may include, but are not limited to, polyethylene, polypropylene, ethylene-vinyl acetate (EVA), styrene-butadiene-styrene (SBS), styrene-isoprene-styrene (SIS), styrene-ethylene-butylene-styrene (SEBS), any copolymer thereof, or any combination thereof. Particularly suitable ethylenically unsaturated polymers may include at least one polymer or copolymer suitable for hygiene applications, such as at least partially crystalline polypropylene (isotactic polypropylene), SBS, SIS, SEBS, any copolymer thereof, or any combination thereof.

Suitable polypropylenes (propylene-based polymers or copolymers) may include propylene homopolymers and copolymers, preferably a random copolymer of propylene, and more preferably an elastomeric random copolymer of propylene and an alpha olefin, such as 1-octene. Such propylene-based polymers may comprise propylene and about 3 to about 50 mole % (mol %) ethylene and/or C₄-C₁₀ α-olefins or C₄-C₂₀ α-olefins, or about 2 to about 40 mol % ethylene and/or C₄-C₁₀ α-olefins or C₄-C₁₀ α-olefins. In some embodiments, the propylene-based polymers may comprise at least about 2 wt. %, at least about 3 wt. %, at least about 5 wt. %, at least about 6 wt. %, at least about 8 wt %, or at least about 10 wt. % of at least one α-olefin and/or up to about 40 wt. %, or up to about 30 wt. %, or up to about 25 wt. %, or up to about 20 wt. %, or up to about 18 wt. %, or up to about 16 wt. %, or up to about 12 wt. % of at least one α-olefin. In some embodiments, the propylene-based polymer may comprise at least one C₄ to C₈ α-olefin. In one or more embodiments, the α-olefin may include ethylene, 1-butene, 1-hexene, 4-methyl-1-pentene, 1-octene, and/or 1-decene, preferably 1-hexene and/or 1-octene.

In some or other embodiments, the propylene-based polymers may comprise at least about 1 mol. %, at least about 2 mol. %, at least about 3 mol. %, at least about 4 mol. %, at least about 5 mol. %, at least about 6 mol. %, at least about 7 mol. %, at least about 8 mol. %, at least about 9 mol. %, at least about 10 mol. %, at least about 11 mol. %, at least about 12 mol. %, at least about 13 mol. %, at least about 14 mol. %, or at least about 15 mol. % of at least one α-olefin and/or up to about 50 mol. %, or up to about 40 mol. %, or up to about 33 mol. %, or up to about 27 mol. %, or up to about 25 mol. %, or up to about 22 mol. %, or up to about 17 mol. % of at least one α-olefin in addition to propylene.

In some or other embodiments, the propylene-based polymers may be characterized by having a single melting temperature (Tm) as determined by differential scanning calorimetry (DSC) according to ASTM D-87. The melting point is defined as the temperature of the greatest heat absorption within the range of melting of the sample. The propylene-based polymers may show secondary melting peaks adjacent to the principal peak, but for purposes herein, these secondary melting peaks may be considered together as a single melting point, with the highest of these peaks being considered the melting point (Tm) of the propylene-based polymer.

In one or more embodiments, the Tm of the propylene-based polymers (as determined by DSC according to ASTM D-87) may be less than about 130° C., or less than about 120° C. or less than about 110° C., or less than about 105° C., or less than about 100° C., or less than about 95° C., or less than about 90° C., or less than about 80° C., or less than about 70° C.

In one or more embodiments, the propylene-based polymers may be characterized by a heat of fusion (Hf), as determined by DSC that is at least about 0.5 Joules/gram (J/g), or at least about 1.0 J/g, or at least about 1.5 J/g, or at least about 3.0 J/g, or at least about 4.0 J/g, or at least about 6.0 J/g, or at least about 7.0 J/g and/or a heat of fusion of less than about 120 J/g, less than about 100 J/g, or less than about 90 J/g, or less than about 80 J/g, or less than about 75 J/g or less than about 70 J/g, or less than about 65 J/g, or less than about 60 J/g, or less than about 55 J/g, or less than about 50 J/g, or less than about 45 J/g, or less than about 40 J/g, or less than about 35 J/g, or less than about 30 J/g.

The propylene-based polymers may have a triad tacticity of three propylene units, as measured by ¹³C NMR, of 75% or greater, 80% or greater, 82% or greater, 85% or greater, or 90% or greater. In one or more embodiments, suitable ranges may include from about 50% to about 99%, or from about 60% to about 99%, or from about 75% to about 99%, or from about 80% to about 99%, or from about 60% to about 97%. Triad tacticity may be determined as described in U.S. Patent Application Publication No. 2004/0236042. Likewise, the propylene-based polymers may have a crystallinity of about 0.5% to about 50%, or about 0.5% to about 40%, or about 1% to about 30%, or about 5% to about 25%, as determined by DSC. Crystallinity may be determined by dividing the heat of fusion of a sample by the heat of fusion of a 100% crystalline polymer, which is assumed to be 189 joules/gram for isotactic polypropylene or 350 joules/gram for polyethylene.

In one or more embodiments, the propylene-based polymers may have a density of about 0.85 g/cm³ to about 0.92 g/cm³, or about 0.87 g/cm³ to about 0.90 g/cm³, or about 0.88 g/cm³ to about 0.89 g/cm³ at room temperature as measured per ASTM D-792.

In one or more embodiments, the propylene-based polymers may have a melt flow rate (MFR), as measured according to the ASTM D-1238, 2.16 kg weight @ 230° C., or greater than or equal to about 0.3 dg/min, or at least about 0.5 dg/min, or at least about 0.8 dg/min, or at least about 1.0 dg/min. In these or other embodiments, the melt flow rate may be equal to or less than about 7000 dg/min, or less than about 6000 dg/min, or less than about 5000 dg/min, or less than about 4000 dg/min, or less than about 3000 dg/min, or less than about 2000 dg/min, or less than about 1000 dg/min, or less than about 900 dg/min, or less than about 700 dg/min, or less than about 500 dg/min, 350 dg/min, or less than about 250 dg/min, or less than about 100 dg/min, and/or greater than or equal to about 250 dg/min, greater than or equal to about 500 dg/min, or greater than or equal to about 1,000 dg/min, or greater than or equal to about 1,500 dg/min, greater than or equal to about 2,000 dg/min, or greater than or equal to about 2,500 dg/min, or greater than or equal to about 3,000 dg/min.

In one or more embodiments, the propylene-based polymers may have a weight average molecular weight (Mw) of about 100,000 g/mole or less, for example, about 5,000 to 5 about 100,000 g/mole, or about 5,000 to about 75,000 g/mole, or about 5,000 to about 50,000 g/mole, or about 10,000 to about 50000 g/mole, or about 20,000 to about 50,000 g/mole, or about 30,000 to about 50,000 g/mole, or about 35,000 to about 50.000 g/mole. In one or more embodiments, the propylene-based polymers may have a number average molecular weight (Mn) of about 2,500 to about 50,000 g/mole, or about 2.500 to about 37.500 g/mole, or about 2.500 to about 25,000 g/mole, or about 15,000 to about 25,000 g/mole. In one or more embodiments, the propylene-based polymers may have a Z-average molecular weight (Mz) of about 10,000 to about 7,000,000 g/mole, or about 50,000 to about 1,000,000 g/mole, or about 80,000 to about 700,000 g/mole, or about 100,000 to about 500.000 g/mole. In one or more embodiments, the molecular weight distribution (MWD=(Mw/Mn)) of the propylene-based polymers may be about 1 to about 40, or about 1 to about 15, or about 1.8 to about 5, or about 1.8 to about 3. In various embodiments, molecular weights may be determined using size exclusion chromatography (SEC).

Suitable styrenic block copolymers, such as SBS, SEBS, or SIS, may include those having a styrene content of about 10 wt. % to about 45 wt. %, or about 15 wt. % to about 35 wt. %, or about 20 wt. % to 30 wt. %, Such styrenic block copolymers may be obtained commercially or produced using well-known anionic solution polymerization techniques, such as those employing lithium-type initiators, e.g., as disclosed in U.S. Pat. Nos. 3,251,905 and 3,239,478, which are hereby incorporated by reference in their entireties. The styrenic block copolymers may be a pure triblock (one having less than 0.1 wt. % of diblock polymer, preferably 0% diblock polymer), or may contain about 0.1 wt. % to about 85 wt. %, or about 0.1 wt. % to about 75 wt. %, or about 1 wt. % to about 65 wt. %, or about 5 wt. % to about 50 wt. %, or about 5 wt. % to 25 wt. %, or about 10 wt. % to 20 wt. % diblock copolymer.

The styrenic block copolymers employed herein may have a number average molecular weight (Mn) (determined by GPC) of about 50,000 to 500,000 g/mol, or about 100,000 to about 180,000 g/mol, or about 110,000 to about 160,000 g/mol, or about 110,000 to about 140.000 g/mol.

Examples of suitable styrenic block copolymers may include, but are not limited to, those available under the trade names VECTOR (from TSRC Dexco Polymers LLP). KRATON (from Kraton Polymers LLC), EUROPRENE (from Polimeri), and FINAPRENE (from Total PetroChemicals). In one or more embodiments, the styrenic block copolymers may have a melt flow rate of about 5 to 40 g/10 min., as measured by ASTM D-1238 using condition G (200° C. 5 kg weight).

Suitable EVA polymers may have an ester comonomer content of about 5 wt. % to about 50 wt. % based on total copolymer mass, or about 10 wt. % to about 40 wt. %, In non-limiting examples, suitable EVA polymers may include those sold under the trade name ESCORENE (ExxonMobil).

A particular thermoplastic polymer and the amount thereof used in the hot melt adhesive compositions disclosed herein may be selected based upon the desired operating temperature and target viscosity. Depending on the particular thermoplastic polymer present in the hot melt adhesive compositions disclosed herein, the ethylenically unsaturated polymer may comprise about 10 wt. % to about 90 wt. % of the hot melt adhesive composition by total mass, such as about 20 wt. % to about 50 wt. %, or about 25 wt. % to about 45 wt. %, or about 30 wt. % to about 45 wt. %, or about 35 wt. % to about 45 wt. %, or about 40 wt. % to about 70 wt. %, or about, or about 50 wt. % to about 65 wt. %, or about 45 wt. % to about 55 wt. %, or about 60 wt. % to about 70 wt. %, or about 65 wt. % to about 90 wt. %, or about 70 wt. % to about 85 wt. %, or about 70 wt. % to about 80 wt. %, In non-limiting examples, the amount of ethylenically unsaturated polymer or copolymer may be about 50 wt. % or below or about 40 wt. % or below, such as within a range from about 20 wt. % to about 50 wt. %, or about 25 wt. % to about 45 wt. %, or about 30 wt. % to about 45 wt. %, or about 35 wt. % to about 45 wt. %, when the thermoplastic polymer comprises at SBS, SEBS, SIS, any copolymer thereof, or any combination thereof. Other thermoplastic polymers affording high melt viscosities may be used in similar ranges. Similarly, in other non-limiting examples, the amount of ethylenically unsaturated polymer or copolymer may be about 50 wt. % or above or about 60 wt. % or above, such as within a range from about 40 wt. % to about 70 wt. %, or about, or about 50 wt. % to about 65 wt. %, or about 45 wt. % to about 55 wt. %, or about 60 wt. % to about 70 wt. %, or about 65 wt. % to about 90 wt. %, or about 70 wt. % to about 85 wt. %, or about 70 wt. % to about 80 wt. %, when the thermoplastic polymer is polypropylene, preferably at least partially crystalline polypropylene, or any copolymer thereof. Other thermoplastic polymers affording low melt viscosities may be used in similar ranges.

Suitable diluents of the present disclosure may comprise one or more C₁₈₊ linear alpha olefins (LAOs) having a kinematic viscosity (ASTM D-445) of about 4 cSt or less at 135° C., one or more LAO dimers formed from the one or more C₁₈₊ LAOs, in which the one or more LAO dimers have an internal olefin and a kinematic viscosity (ASTM D-445) of about 6 cSt or less at 135° C., or one or more paraffinic hydrocarbons having an even carbon number distribution and formed through dimerization of one or more C₁₈₊ linear alpha olefins (LAOs) and subsequent reduction, the one or more C₁₈₊ LAOs having a kinematic viscosity (ASTM D-445) before dimerization of about 4 cSt or less at 135° C. Paraffinic hydrocarbons formed from one or more LAO dimer may have a kinematic viscosity that is higher than the latter. Optionally, such diluents may be present in combination with a paraffinic hydrocarbon oil and/or a paraffinic hydrocarbon wax, such as a Fischer-Tropsch wax.

Processes suitable for forming LAOs for use in the disclosure herein are not believed to be particularly limited. LAOs within the foregoing size ranges for forming a suitable diluent for hot melt adhesives may be synthesized by several different processes starting from low molecular weight feedstock materials. A primary route for synthesizing LAOs is via ethylene oligomerization, of which there are several synthetic variants that may be mediated using different Ziegler-type catalysts. Depending on the particular Ziegler-type catalyst and the synthetic conditions, ethylene oligomerization reactions may form a range of homologous LAOs having an even number of carbon atoms (i.e., C₂ₙH₂ₙ, where n is a positive integer greater than or equal to 2), or a predominant LAO (e.g., 1-butene, 1-hexene, 1-octene, or 1-decene) may be produced. When multiple LAOs are formed, the product distribution of the LAOs may follow a Schulz-Flory distribution, with the distribution being arranged about a central molecular weight. Such processes are commonly referred to as full-range or wide-range LAO synthesis processes. LAO syntheses affording a predominant LAO (e.g., about 70% or more or even about 90% or more of the LAOs in the product stream) may also form up to about 10 wt. % of other minor product LAOs and additional byproducts. Such LAO syntheses are referred to herein as being “specific” LAO syntheses, and they may sometimes be referred to in the art as “on-purpose” LAO syntheses.

Fractional distillation processes are frequently employed to separate LAO product streams into desired fractions comprising individual or multiple LAOs. Typical distillation processes for separating LAOs from one another may employ a two-product distillation column to isolate an overhead stream comprising an individual LAO or LAO mixture and a bottoms stream comprising a mixture of LAOs having higher boiling points than those obtained in the overhead stream. This process is iterated until LAOs up to a desired carbon count have been separated from one another. In the case of the present disclosure, C₁₈-C₂₄ or C₂₀-C₂₄ LAOs may be obtained as an overhead stream during distillation and C₂₄₊ LAOs may be obtained separately as a bottoms stream. The LAOs in each fraction may have an even carbon count (i.e., contain C₂ₙ carbon atoms, wherein n is an integer greater than or equal to 2). Preferably, C₁₈₊ LAOs may comprise predominantly C₁₈-C₂₄ LAOs, C₂₈-C₂₄ LAOs, or C₂₄. LAOs, including their dimer and reduced dimeric reaction products.

Suitable diluents may also be obtained through dimerization of C₁₈-C₂₄, C₂₀-C₂₄, or C₂₄₊ LAOs to obtain LAO dimers having 2n-2 carbon atoms, wherein n is the number of carbon atoms in the LAOs undergoing dimerization. Sources for the LAOs undergoing dimerization may include any of those described above, such as but not limited to, LAOs obtained from ethylene oligomerization, fatty alcohol dehydration, renewable/biomass-derived LAOs (e.g., obtained from lactones, unsaturated fatty acids, ethanol, or the like), or any combination of these. Dimerization may occur through a metathesis process in the presence of a suitable metal carbene catalyst, resulting in loss of ethylene and formation of a linear olefin dimer having an internal double bond. Dimerization may take place in a continuous mode, such as in a continuous stirred tank reactor or a tubular reactor. The resulting LAO dimers may be further reduced into the corresponding paraffins, in which the paraffins likewise have an even number carbon distribution.

Accordingly, C₁₈₊ LAOs may comprise suitable diluents or serve as a precursor to suitable diluents in the disclosure herein, wherein the C₁₈₊ LAOs may comprise predominantly C₁₈-C₂₄ LAOs, predominantly C₂₀-C₂₄ LAOs, or predominantly C₂₄₊ LAOs.

C₂₀-C₂₄ LAOs may have a kinematic viscosity (ASTM D-445) of about 5 cSt or less or about 4 cSt or less at 135° C., such as about 1 cSt to about 4 cSt at 135° C., or about 1.5 cSt to about 3.5 cSt at 135° C., or about 2 cSt to about 3 cSt at 135° C., or about 1 cSt to about 2 cSt at 135° C., or about 1 cSt to about 1.5 cSt at 135° C.; a congealing point (ASTM D-938) ranging from about 5° C. to about 150° C., or from about 10° C. to about 140° C., or from about 15° C. to about 130° C., or from about 20° C. to about 120° C., or from about 25° C. to about 110° C., or from about 30° C. to about 100° C.; and a melting point (ASTM D-87) ranging from about 5° C. to about 200° C., or from about 10° C. to about 175° C., or from about 15° C. to about 150° C., or from about 20° C. to about 125° C., or from about 25° C. to about 100° C.

A sample containing C₂₀-C₂₄ LAOs may have an alpha olefin content ranging from about 50 mol. % to about 100 mol. %, or about 55 mol. % to about 95 mol. %, or about 60 mol. % to about 90 mol. %, or about 65 mol. % to about 85 mol. %, or about 70 mol. % to about 80 mol. %; a vinylidene olefin content ranging from about 1 mol. % to about 30 mol. %, or about 2 mol. % to about 20 mol. %, or about 3 mol. % to about 10 mol. %; and an internal olefin content of about 10 mol. % or less, such as an internal olefin content ranging from 0 mol. % to about 10 mol. %, or 0 mol. % to about 4 mol. %.

C₂₄₊ LAOs may have a kinematic viscosity (ASTM D-445) of about 4 cSt or less or about 5 cSt or less at 135° C., such as about 1 cSt to about 4 cSt at 135° C., or about 1.5 cSt to about 3.5 cSt at 135° C., or about 2 cSt to about 3 cSt at 135° C., or about 1 cSt to about 2 cSt at 135° C., or about 1 cSt to about 1.5 cSt at 135° C.; a congealing point (ASTM D-938) ranging from about 5° C. to about 150° C., or from about 10° C. to about 140° C., or from about 15° C. to about 130° C., or from about 20° C. to about 120° C., or from about 25° C. to about 110° C., or from about 30° C. to about 100° C.; and a melting point (ASTM D-87) ranging from about 5° C. to about 200° C., or from about 10° C. to about 175° C., or from about 15° C. to about 150° C., or from about 20° C. to about 125° C., or from about 25° C. to about 100° C.

A sample containing C₂. LAOs may have an alpha olefin content ranging from about 50 mol. % to about 100 mol. %, or about 55 mol. % to about 95 mol. %, or about 60 mol. % to about 90 mol. %, or about 65 mol. % to about 85 mol. %, or about 70 mol. % to about 80 mol. %; a vinylidene olefin content ranging from about 1 mol. % to about 30 mol. %, or about 2 mol. % to about 20 mol. %, or about 3 mol. % to about 10 mol. %; and an internal olefin content of about 10 mol. % or less, such as an internal olefin content ranging from 0 mol. % to about 10 mol. %, or 0 mol. % to about 4 mol. %.

Any of the C₁₈₊ LAOs described above may be dimerized to form LAO dimers having an internal olefin, which may also be suitably incorporated as a diluent in the hot melt adhesive compositions described herein. Such LAO dimers may be formed through metathesis-based dimerization and have two carbon atoms less than the two LAO molecules from which the LAO dimers are produced. The LAO dimers may have an even carbon number distribution. When multiple LAOs are dimerized, the LAO dimers may exhibit a range of carbon numbers, again with an even number carbon distribution. The LAO dimers may be further reduced (hydrogenated) to form paraffinic hydrocarbons likewise having an even carbon number distribution, as described herein, which may also be suitably included in the hot melt adhesive compositions of the present disclosure. Suitable LAO dimers comprising an internal olefin (e.g., C₃₄-C₄₆ LAO dimers or C₄₆₊ LAO dimers) may have a kinematic viscosity (ASTM D-445) of about 3.5 cSt to about 5.5 cSt or about 4 cSt to about 5.5 cSt at 135° C. Suitable paraffinic hydrocarbons formed from such LAO dimers may feature an even carbon number distribution and a kinematic viscosity (ASTM D-445) of about 8 cSt or less at 135° C., such as a kinematic viscosity (ASTM D-445) of about 4 cSt to about 8 cSt at 135° C.

In some embodiments, the diluents of the present disclosure may comprise C₁₈₊ LAOs, LAO dimers, or paraffinic hydrocarbons formed from LAO dimers in combination with a paraffinic hydrocarbon oil and/or a paraffinic hydrocarbon wax, such as a Fischer-Tropsch wax. A suitable ratio of LAOs to paraffinic hydrocarbon oil and/or paraffinic hydrocarbon wax may range from about 9:1 to about 1:9 on a weight basis. A suitable ratio of LAO dimers to paraffinic hydrocarbon oil and/or paraffinic hydrocarbon wax may range from about 9:1 to about 1:9 on a weight basis. A suitable ratio of paraffinic hydrocarbons formed from LAO dimers to paraffinic hydrocarbon oil and/or paraffinic hydrocarbon wax may range from about 9:1 to about 1:9 on a weight basis. In each case, the chosen ratio may be selected to convey a desired viscosity value to the hot melt adhesive composition.

Illustrative paraffinic hydrocarbon waxes that may be present in combination with the LAO-derived diluents disclosed herein include, but are not limited to, PARVAN™ 1580 (ExxonMobil), RHEOLUB® RL165 and RHEOLUB® RL250 (Honeywell Industries). Other suitable paraffinic hydrocarbon waxes may include, for example, INTERFLO 66 and INTERFLO L-6530b from International Group, SYNERTIVE RX-165 and SYNERTIVE RX-170 from Rheogistics LLC, MR7073 and MR7173 from Masterrank Wax, Inc., PETRAC 165 and PETRAC 200 from Valtris Specialty Chemicals, and REALUBE RW70 and RW73 from Reagens.

Illustrative paraffinic hydrocarbon waxes that are Fischer-Tropsch waxes and may be present in combination with the LAO-derived diluents include those produced by conversion of natural gas or gasification of coal under known conditions to produce synthesis gas (CO+H₂). Common Fischer-Tropsch waxes may have a melting point of about 75° C. or greater and/or feature a carbon count of about C₁₉₊ or higher, wherein there is a continuous distribution of carbon chain sizes. Illustrative Fischer-Tropsch waxes may include, but are not limited to, high-melting Fischer-Tropsch waxes such as SASOLWAX C80, SASOLWAX™ B52, SASOLWAX6600™, SASOLWAX6800™, and SASOLWAX™ H1 (available from Sasol). Functionalized Fischer-Tropsch waxes may be suitable in some instances.

Paraffinic hydrocarbon oils (e.g., paraffinic white oils) that may be used in combination the LAO-derived diluents disclosed herein may include, but are not limited to, paraffinic or naphthenic oils such as PRIMOL 352 or SENTINEL PO 876 (ExxonMobil), and NYFLEX 222B, available from Nynas AB. Such paraffinic or naphthenic hydrocarbon oils may have a Cₙ carbon number distribution and include about 40% branched paraffins, or about 45% branched paraffins or greater, or about 50% branched paraffins or greater, or about 55% branched paraffins or greater, or about 60% branched paraffins or greater, on a weight basis.

The LAO-derived diluents disclosed herein, optionally in further combination with a paraffinic white oil or paraffinic wax, may be present in the hot melt adhesive compositions in an amount ranging from about 1 wt. % to about 50 wt. %, based on total mass of the hot melt adhesive composition, or about 3 wt. % to about 30 wt. %, or about 5 wt. % to about 25 wt. %, or about 7 wt. % to about 22 wt. %, or about 5 wt. % to about 15 wt. %, or about 10 wt. % to about 20 wt. %, or about 10 wt. % to about 25 wt. %.

The hot melt adhesive compositions described herein may comprise a tackifier, also referred to as a tackifier resin component, comprising one or more hydrocarbon tackifier resins, as described further herein. Tackifier resin components may include amorphous, low molecular weight natural or synthetic hydrocarbon resin materials that modify the adhesive characteristics. Natural resins may include resins of plant or animal origin which include but are not limited to rosins such as gum, wood, or tall oil rosins. Synthetic resins may include resins resulting from controlled chemical reactions, such as hydrocarbon resins produced from such reactions. Examples of synthetic hydrocarbon resins may include coal tar resins, petroleum resins, and turpentine resins.

Examples of suitable tackifier resin components may include, but are not limited to, aliphatic hydrocarbon resins, aromatic modified aliphatic hydrocarbon resins, hydrogenated polycyclopentadiene resins, polycyclopentadiene resins, gum rosins, gum rosin esters, wood rosins, wood rosin esters, tall oil rosins, tall oil rosin esters, polyterpenes, aromatic modified polyterpenes, terpene phenolics, aromatic modified hydrogenated polycyclopentadiene resins, hydrogenated aliphatic resin, hydrogenated aliphatic aromatic resins, phenolic resins, hydrogenated terpenes and modified terpenes, hydrogenated rosin acids, and hydrogenated rosin esters. In some embodiments, the tackifier resin component may be substantially free of monomers having polar groups. If present, polar groups may comprise not more than 5 wt. %, preferably not more than 2 wt. %, even more preferably no more than 0.5 wt. %, of the tackifier. Suitable tackifiers may have a softening point (Ring and Ball, as measured by ASTM E-28) of about 80° C. to about 150° C., preferably about 100° C. to about 130° C. Other suitable tackifiers may be a liquid resin having a softening point of about 10° C. top about 70° C.

The tackifier may be present in the hot melt adhesives disclosed herein in an amount of at least about 1 wt. %, at least about 10 wt. %, at least about 20 wt. %, at least about 30 wt. %, at least about 40 wt. %, at least about 50 wt. %, at least about 60 wt. %, or at least about 70 wt. %, each based on total mass of the hot melt adhesive. In more specific embodiments, the tackifier may be present in an amount ranging from about 5 wt. % to about 45 wt. %, or about 10 wt. % to about 40 wt. %, or about 15 wt. % to about 30 wt. %, or about 20 wt. % to about 35 wt. %, or about 45 wt. % to about 75 wt. %, or about 50 wt. % to about 70 wt. %, or about 55 wt. % to about 75 wt. %, or about 60 wt. % to about 70 wt. %.

More specific examples of tackifiers may include:
(a) Resins such as C₅/C₆ terpene resins, styrene terpenes, alpha-methyl styrene terpene resins, C₉ terpene resins, aromatic modified C₅/C₆, aromatic modified cyclic resins, aromatic modified dicyclopentadiene based resins or mixtures thereof. Additional resins may include those described in International Patent Application Publication 91/07472 and U.S. Pat. Nos. 5,571,867, 5,171,793 and 4,078,132. Such resins may be obtained from cationic polymerization of one or more of the following monomers: C₅ diolefins (e.g., 1.3 pentadiene, isoprene, and the like); C₅ olefins (e.g., 2-methylbutenes, cyclopentene, and the like); C₆ olefins (e.g., 1-hexene), C₉ vinylaromatics (e.g., styrene, alpha methyl styrene, vinyltoluene, indene, methyl indene, and the like.), cyclics (e.g., dicyclopentadiene, methyldicyclopentadiene, and the like), and/or terpenes (e.g., limonene, carene, and the like);
(b) Resins obtained by thermal polymerization of dicyclopentadiene, and/or thermal polymerization of dimers or oligomers of cyclopentadiene and/or methylcyclopentadiene, optionally with vinylaromatics (e.g., styrene, alpha-methyl styrene, vinyl toluene, indene, methyl indene, and the like).

In one embodiment, the tackifier resin component may comprise one or more hydrocarbon resins produced by the thermal polymerization of cyclopentadiene or a substituted cyclopentadiene, which may further include aliphatic or aromatic monomers. The hydrocarbon resin may be a non-aromatic resin or an aromatic resin. The hydrocarbon resin may have an aromatic content of 0% to about 60% based on total weight of the tackifier resin, preferably of about 1% to about 60%, or about 1% to about 40%, or about 1% to about 20%, or about 10% to about 20%, or about 15% to about 20%, or about 1% to about 10%, or about 5% to about 10%.

Other suitable tackifiers may comprise hydrocarbon resins produced by the catalytic (cationic) polymerization of linear dienes. Such monomers are primarily derived from Steam Cracked Naptha (SCN) and include C₅ dienes such as piperylene (1,3-pentadiene). Polymerizable aromatic monomers (e.g., styrene, alpha-methyl styrene, or a C₉-aromatic SCN stream) can also be used to produce such resins. Such aromatic monomers can be used alone or in combination with the linear dienes previously described. “Natural” monomers, such terpenes including α-pinene or β-carene, can also be used to produce resins, either alone or in high or low concentrations with other polymerizable monomers. Typical catalysts used to make these resins are AlCl₃ and BF₃, either alone or in complexed form. Mono-olefin modifiers such as 2-methyl-2-butene may also be used to control the molecular weight distribution (MWD) of the final resin. The final resin may be at least partially or totally hydrogenated. As used herein, “at least partially hydrogenated” means that the material contains less than 90% olefinic protons relative to unhydrogenated material, or less than 75% olefinic protons, or less than 50% olefinic protons, or less than 40% olefinic protons, or less than 25% olefinic protons. As used herein, “substantially hydrogenated” means that the material contains less than 5% olefinic protons relative to unhydrogenated material, or less than 4% olefinic protons, or less than 3% olefinic protons, or less than 2% olefinic protons. Hydrogenation may be conducted to substantially avoid hydrogenation of the aromatic bonds.

Tackifier resin components may be characterized as totally or substantially amorphous in nature, meaning that they may exhibit a glass transition temperature (T_{g}) by Differential Scanning calorimetry (DSC) but they have no melting point (Tₘ). To characterize these resins, it is generally accepted to use a test that roughly correlates with T_{g}, such as softening point (SP), which may provide an approximate value. Softening point may be measured by a ring-and-ball softening point test according to ASTM E-28.

In some embodiments, suitable tackifiers may have a softening point of about 50° C. to about 140° C., or from about 60° C. to about 130° C., or about 70° C. to about 120° C., or about 80° C. to about 110° C.

Suitable tackifier resin components may have a number average molecular weight (Mn) of about 400 to about 3000, a weight average molecular weight (Mw) of about 500 to about 6000, a Z-average molecular weight (Mz) of about 700 to about 15,000 and a polydispersity (PD), defined as Mw/Mn, of about 1.5 to about 4. Such molecular weights may be measured by size exclusion chromatography using a Waters 150 Gel Permeation Chromatograph equipped with a differential refractive index detector and calibrated using polystyrene standards. Samples are run in tetrahydrofuran (THF) at 45° C. Molecular weights are reported as polystyrene-equivalent molecular weights and are measured in g/mol.

The tackifier resin component may comprise one or more oligomers such as dimers, trimers, tetramers, pentamers, and hexamers. The oligomers may be derived from a petroleum distillate boiling in the range of about 30° C. to about 210° C. The oligomers may be derived from any suitable process, such as a byproduct of resin polymerization. Suitable oligomer streams may have molecular weights (Mn) of about 130 to about 500 g/mol, or about 130 to about 410 g/mol, or about 130 to about 350 g/mol, or about 130 to about 270 g/mol, or about 200 to about 350 g/mol, or about 200 to about 320 g/mol. Examples of suitable oligomer streams may include, but are not limited to, oligomers of cyclopentadiene and substituted cyclopentadiene, oligomers of C₄-C₆ conjugated diolefins, oligomers of C₈-C₁₀ aromatic olefins, and combinations thereof. Other monomers may be present, such as C₄-C₆ mono-olefins and terpenes. The oligomers may comprise one or more aromatic monomers and may be at least partially hydrogenated or substantially hydrogenated.

Examples of commercially available tackifiers include, but are not limited to, ESCOREZ (ExxonMobil), OPPERA (ExxonMobil), PICCOTAC 1905, REGALREZ 5095, REGALREZ 3102, STAYBELITE ESTER 3, PENTALYN H and EASTOTAC H-100 (Eastman Chemicals), QUINTONE D and QUINTONE U 185 (Nippon Zeon), MARUKARES R100 (Maruzen), WINGTACK EXTRA and WINGTACK PLUS (Cray Valley), SYLVALITE RE 885 and SYLVATAC RE 85 (Arizona Chemical), and SUKOREZ, HIKOREZ, and HIKOTACK (Kolon Industries).

Another class of resins that may be employed is terpene resins, including styrenated terpenes. These terpene resins can have a molecular weight (Mw) that ranges from about 600 g/mol to about 6.000 g/mol. Typical commercially available resins of this type are marketed as PICCOLYTE S-100, as STAYBELITE ESTER #10, which is a glycerol ester of hydrogenated rosin, and as WINGTACK 95, which is a polyterpene resin.

Another class of resins that may be employed is the butadiene-styrene resins having a molecular weight of about 500 g/mol to about 5,000 g/mol. A non-limiting example of this type of resin that is commercially available is marketed as BUTON 100, a liquid butadiene-styrene copolymer resin having a molecular weight of about 2,500 g/mol. Still another class of resins is polybutadiene resins having a molecular weight (Mw) of about 500 g/mol to about 5,000 g/mol. A non-limiting example of this type of resin that is commercially available is marketed as BUTON 150, a liquid polybutadiene resin having a molecular weight (Mw) of from about 2,000 g/mol to about 2,500 g/mol.

Another class of resins that may be employed are the so-called hydrocarbon resins produced by catalytic polymerization of selected fractions obtained in the refining of petroleum, and having a molecular weight (Mw) of about 500 g/mol to about 5,000 g/mol. Examples of such resin are those marketed as PICCOPALE-100, and as AMOCO and VELSICOL resins. Similarly, polybutenes obtained from the polymerization of isobutylene may be included as a tackifier.

The resin may also include rosin materials, such as low molecular weight styrene hard resins such as the material marketed as PICCOLASTIC A-75, disproportionated pentaerythritol esters, and copolymers of aromatic and aliphatic monomer systems of the type marketed as VELSICOL WX-1232. Rosins may be any standard material of commerce known as “rosin”, or a feedstock containing rosin. Rosin is mainly a mixture of C₂₀, tricyclic fused-ring, monocarboxylic acids, typified by pimaric and abietic acids, which are commonly referred to as “resin acids.” Any one or more of the C₂₀ cyclic carboxylic acid-containing isomers present in rosin may be used. Rosin is the residue left after distilling off the volatile oil from the oleoresin obtained from Pinus palustris and other species of Pinus. It is available as wood rosin (from Southern pine stumps after harvesting the stumps, chipping the stumps into small chips, extracting the chips with hexane or higher-boiling paraffin, and distilling the hexane or paraffin to yield wood rosin) gum rosin (the exudates from incisions in the living tree. P. palustris and P. caribaea) and tall oil rosin. Rosin contains about 90% resin acids and about 10% neutral matter. The acids present in natural rosin may be purified by, for example, by saponification, extraction of the neutral matter and reacidifying. Of the resin acids about 90% are isomeric with abietic acid (C₂₀H₃₀O₂); the other 10% is a mixture of dihydroabietic acid (C₂₀H₃₂O₂) and dehydroabietic acid (C₂₀H₂₈O₂). Tall oil, also known as liquid rosin, is a byproduct of the wood pulp industry and is usually recovered from pinewood “black liquor” of the sulfate or Kraft paper process. According to the Kraft process, pinewood is digested with alkali and sulfide, producing tall oil soap and crude sulfate turpentine as by-products. Acidification of this soap followed by fractionation of the crude tall oil yields tall oil rosin and fatty acids. Tall oil typically contains rosin acids (about 34 wt. % to about 40 wt. %), fatty acids such as oleic and linoleic acids (about 50 wt. % to about 60 wt. %) and neutral matter (about 5 wt. % to about 10 wt. %). For example, the rosin can contain at least about 90 wt. % resin acids and less than about 10 wt. % fatty acids. Some rosin dimerization product, which may form during the fractionation process, may also be present in the tall oil rosin. Rosin is available commercially in several grades (for example, under the tradename RESINALL from Resinall Corporation, and other products supplied by Hercules, Aarakawa, etc.). A standard grade of rosin is available commercially from Union Camp Corporation (Wayne, N.J.) under the UNITOL tradename. Commercially available rosins that can be used to practice the present disclosure also include SYLVARES RE 115 and SYLVARES RE 104, available from Arizona Chemical.

As used herein, the term “rosin” collectively includes natural rosins, liquid rosins, modified rosins and the purified rosin acids, and derivatives of rosin acids, including partially to completely neutralized salts with metal ions, e.g. resinate, etc. The rosin may be gum, wood or tall oil rosin. The rosin material may be modified rosin such as dimerized rosin, hydrogenated rosin, disproportionated rosin, or esters of rosin. Essentially any reaction conditions recognized in the art for preparing modified rosin resins (including derivatives thereof) may be employed to prepare a modified rosin. Rosins can be modified by, for example, esterification of some or all of the carboxylic moieties or by forming carboxylate salts by saponification. Esters can be prepared by esterifying the rosin with polyhydric alcohols containing from 2 to 6 alcohol groups.

Phenolic-modified rosin esters can be prepared by the reaction of rosin and a phenolic compound. This phenolic resin is then esterified with a polyhydric alcohol providing phenolic-modified rosin esters. Typically, the combinations of reactants are exposed to an elevated temperature in the range of about 100° C. to about 300° C. At these elevated temperatures, the reactants undergo covalent bond-forming reactions with other reactants, so that a resinous material is formed. Reaction products of rosins and their methods of preparation are described further in U.S. Pat. No. 2,007,983.

Aromatic tackifiers may include thermoplastic hydrocarbon resins derived from styrene, alpha-methylstyrene, and/or vinyltoluene, and polymers, copolymers and terpolymers thereof, terpenes, terpene phenolics, modified terpenes, and combinations thereof. KRYSTALEX 3100 is an example low molecular weight thermoplastic hydrocarbon polymer derived largely from alpha-methylstryene with a Ring and Ball softening point of about 97° C. to about 103° C., commercially available from Hercules Inc.

In some embodiments, one or more additional components may be employed to modify the properties and characteristics in the final hot melt adhesive composition. Such additional components may include, but are not limited to fillers, cavitating agents, antioxidants, surfactants, adjuvants, plasticizers, block, antiblock, colorants, color masterbatches, pigments, dyes, processing aids. UV stabilizers, neutralizers, lubricants, waxes, and/or nucleating agents. The additives may be present in any amount determined to be effective by those skilled in the art, such as, for example, from about 0.001 wt. % to about 10 wt. % based on total mass of the hot melt adhesive.

Examples of suitable antioxidants may include, but are not limited to, quinolines (e.g., trimethylhydroxyquinoline (TMQ)), imidazoles (e.g., zinemercapto toluyl imidazole (ZMTI)), and conventional antioxidants, such as hindered phenols, lactones, phosphates, and hindered amines Further suitable anti-oxidants are commercially available from, for example, Ciba Geigy Corp. under the trade names IRGAFOS 168, IRGANOX 1010, IRGANOX 3790, IRGANOX B225, IRGANOX 1035, IRGAFOS 126, IRGASTAB 410, and CHIMASSORB 944.

Fillers, cavitating agents and/or nucleating agents suitable for use in the hot melt adhesives may include granular, fibrous, and powder-like materials, such as but not limited to, titanium dioxide, calcium carbonate, barium sulfate, silica, silicon dioxide, carbon black, sand, glass beads, mineral aggregates, talc, natural and synthetic clays, diatomaceous earth, and the like.

Plasticizers may include conventional plasticizers known to those skilled in the art, including mineral oils, phthalates, or polybutenes, such as PARAPOL 950 and PARAPOL 1300 formerly available from ExxonMobil Chemical Company. Suitable plasticizers may also include phthalates such as di-iso-undecyl phthalate (DIUP), di-iso-nonylphthalate (DINP), and dioctylphthalates (DOP).

Adhesion promoters may include conventional adhesion promoters known to those skilled in the art. Adhesion promoters may include polar acids, polyaminoamides, such as VERSAMID 115, 125, 140, available from Henkel, urethanes, such as isocyanate/hydroxy terminated polyester systems, e.g., bonding agent TN/Mondur Cb-75 (Miles, Inc.), coupling agents, such as silane esters (Z-6020 from Dow Corning), titanate esters, such as Kr-44 available from Kenrich, reactive acrylate monomers, such as SAR BOX SB-600 from Sartomer, metal acid salts, such as SARET 633 from Sartomer, and polyphenylene oxide.

Depending on the chosen polymer and amount thereof, among other factors, the viscosity of the hot melt adhesive compositions may be varied according to application-specific needs. In non-limiting examples, the hot melt adhesive compositions may exhibit a Brookfield viscosity (ASTM D-3236) of about 8000 cP or lower at 140° C., or about 7000 cP or lower at 140° C., or about 6000 cP or lower at 140° C., or about 5000 cP or lower at 140° C., or about 4000 cP or lower at 140° C., or about 3000 cP or lower at 140° C., or about 2000 cP or lower at 140° C., or about 1000 cP or lower at 140° C.

Likewise, the T-peel adhesion strength of the hot melt adhesive compositions may be varied according to application-specific needs. In non-limiting examples, T-peel strength may be measured by ASTM D-903 at 1 day and be about 90 g or higher or about 100 g or higher, such as about 100 g to about 200 g, or about 105 g to about 180 g, or about 100 g to about 150 g, or about 110 g to about 140 g.

Embodiments disclosed herein include:
A. Hot melt adhesive compositions containing LAO dimers or paraffinic hydrocarbons obtained from LAO dimers. The adhesive compositions comprise: an ethylenically unsaturated polymer or copolymer; a tackifier; and a diluent comprising at least one of: one or more LAO dimers formed from one or more C₁₈₊ LAOs, the one or more LAO dimers having an internal olefin and a kinematic viscosity (ASTM D445) of about 6 cSt or less at 135° C.; or one or more paraffinic hydrocarbons having an even carbon number distribution and formed through dimerization of one or more C₁₈₊ LAOs and subsequent reduction, the one or more C₁₈₊ LAOs having a kinematic viscosity (ASTM D445) before dimerization of about 4 cSt or less at 135° C.
B. Hot melt adhesive compositions comprising a polypropylene polymer or copolymer. The adhesive compositions comprise: about 60 wt. % or above of a polypropylene polymer or copolymer; a tackifier; and a diluent comprising at least one of: one or more C₁₈₊ linear alpha olefins (LAOs) having a kinematic viscosity (ASTM D445) of about 4 cSt or less at 135° C.; one or more LAO dimers formed from one or more C₁₈₊ LAOs, the one or more LAO dimers having an internal olefin and a kinematic viscosity (ASTM D445) of about 6 cSt or less at 135° C.; or one or more paraffinic hydrocarbons having an even carbon number distribution and formed through dimerization of one or more C₁₈₊ LAOs and subsequent reduction, the one or more C₁₈₊ LAOs having a kinematic viscosity (ASTM D445) before dimerization of about 4 cSt or less at 135° C.
C. Hot melt adhesive compositions comprising a styrenic block copolymer. The adhesive compositions comprise: a styrenic block copolymer; a tackifier; and a diluent comprising at least one of: one or more C₁₈₊ linear alpha olefins (LAOs) having a kinematic viscosity (ASTM D445) of about 4 cSt or less at 135° C.; one or more LAO dimers formed from one or more C₁₈₊ LAOs, the one or more LAO dimers having an internal olefin and a kinematic viscosity (ASTM D445) of about 6 cSt or less at 135° C.; or one or more paraffinic hydrocarbons having an even carbon number distribution and formed through dimerization of one or more C₁₈₊ LAOs and subsequent reduction, the one or more C₁₈₊ LAOs having a kinematic viscosity (ASTM D445) before dimerization of about 4 cSt or less at 135° C.

Embodiments A-C may have one or more of the following additional elements in any combination:

Element 1: wherein the ethylenically unsaturated polymer or copolymer comprises at least one polymer selected from the group consisting of polyethylene, polypropylene, ethylene-vinyl acetate, a styrenic block copolymer, any copolymer thereof, and any combination thereof.

Element 2: wherein the styrenic block copolymer comprises styrene-butadiene-styrene, styrene-isoprene-styrene, styrene-ethylene-butylene-styrene, any copolymer thereof, and any combination thereof.

Element 3: wherein the adhesive composition further comprises a paraffinic hydrocarbon oil, a paraffinic hydrocarbon wax, or any combination thereof.

Element 4: wherein the adhesive composition has a T-peel strength of about 100 g or greater at 1 day, as measured by ASTM D903.

Element 5: wherein the adhesive composition has a Brookfield viscosity (ASTM D3236) of about 8000 cP or lower at 140° C.

Element 6: wherein the one or more C₁₈₊ LAOs comprise predominantly C₂₀-C₂₄ LAOs, or C₂₄₊ LAOs.

Element 7: wherein the one or more LAO dimers have a kinematic viscosity (ASTM D445) of about 4 cSt to about 5.5 cSt at 135° C.

Element 8: wherein the one or more C₁₈₊ LAOs have a kinematic viscosity (ASTM D445) of about 1 cSt to about 4 cSt at 135° C.

Element 9: wherein the one or more paraffinic hydrocarbons formed through dimerization of one or more C₁₈₊ LAOs and subsequent reduction have a kinematic viscosity (ASTM D445) of about 4 cSt to about 8 cSt at 135° C.

Element 10: wherein the diluent comprises at least one of the one or more LAO dimers or the one or more paraffinic hydrocarbons.

Element 11: wherein the styrenic block copolymer comprises about 40 wt. % or less of the adhesive composition.

By way of non-limiting example, illustrative combinations applicable to one or more of A-C may include, but are not limited to, 1 and 3; 1 and 4; 1 and 5, 1, and 6, 7, and/or 8; 1 and 9; 1 and 10; 1 and 11; 1-3; 1, 2, and 4; 1, 2, and 5; 1, 2, and 6, 7, and/or 8; 1,2, and 9; 1, 2, and 10; 1, 2, and 11; 3 and 4; 3 and 5; 3, and 6, 7, and/or 8; 3 and 9; 3 and 10; 3 and 11; 4 and/or 5, and 6, 7, and/or 8; 4 and/or 5, and 9, 4 and/or 5, and 10; 4 and/or 5, and 11; 6, 7, and/or 8; and 9; 6, 7, and/or 8, and 10; 6, 7, and/or 8, and 11; 9 and 10; 9 and 11; and 10 and 11.

The present disclosure is also directed to the following non-limiting embodiments:

Embodiment 1. An adhesive composition comprising:
an ethylenically unsaturated polymer or copolymer;
a tackifier; and
a diluent comprising at least one of:
   one or more LAO dimers formed from one or more C₁₈₊ LAOs, the one or more LAO dimers having an internal olefin and a kinematic viscosity (ASTM D445) of about 6 cSt or less at 135° C.; or
   one or more paraffinic hydrocarbons having an even carbon number distribution and formed through dimerization of one or more C₁₈₊ LAOs and subsequent reduction, the one or more C₁₈₊ LAOs having a kinematic viscosity (ASTM D445) before dimerization of about 4 cSt or less at 135° C.

Embodiment 2. The adhesive composition of Embodiment 1, wherein the ethylenically unsaturated polymer or copolymer comprises at least one polymer selected from the group consisting of polyethylene, polypropylene, ethylene-vinyl acetate, a styrenic block copolymer, any copolymer thereof, and any combination thereof.

Embodiment 3. The adhesive composition of Embodiment 2, wherein the styrenic block copolymer comprises styrene-butadiene-styrene, styrene-isoprene-styrene, styrene-ethylene-butylene-styrene, any copolymer thereof, and any combination thereof.

Embodiment 4. The adhesive composition of any one of Embodiments 1-3, further comprising:
a paraffinic hydrocarbon oil, a paraffinic hydrocarbon wax, or any combination thereof.

Embodiment 5. The adhesive composition of any one of Embodiments 1-4, wherein the adhesive composition has a T-peel strength of about 100 g or greater at 1 day, as measured by ASTM D903.

Embodiment 6. The adhesive composition of any one of Embodiments 1-5, wherein the adhesive composition has a Brookfield viscosity (ASTM D3236) of about 8000 cP or lower at 140° C.

Embodiment 7. The adhesive composition of any one of Embodiments 1-6, wherein the one or more C₁₈₊ LAOs comprise predominantly C₂₀-C₂₄ LAOs, or C₂₄₊ LAOs.

Embodiment 8. The adhesive composition of any one of claims 1-10, wherein the one or more LAO dimers have a kinematic viscosity (ASTM D445) of about 4 cSt to about 5.5 cSt at 135° C.

Embodiment 9. The adhesive composition of any one of Embodiments 1-7, wherein the one or more paraffinic hydrocarbons formed through dimerization of one or more C₁₈₊ LAOs and subsequent reduction have a kinematic viscosity (ASTM D445) of about 4 cSt to about 8 cSt at 135° C.

Embodiment 10. An adhesive composition comprising:
about 60 wt. % or above of a polypropylene polymer or copolymer;
a tackifier; and
a diluent comprising at least one of:
   one or more C₁₈₊ linear alpha olefins (LAOs) having a kinematic viscosity (ASTM D445) of about 4 cSt or less at 135° C.;
   one or more LAO dimers formed from one or more C₁₈₊ LAOs, the one or more LAO dimers having an internal olefin and a kinematic viscosity (ASTM D445) of about 6 cSt or less at 135° C.; or
   one or more paraffinic hydrocarbons having an even carbon number distribution and formed through dimerization of one or more C₁₈₊ LAOs and subsequent reduction, the one or more C₁₈₊ LAOs having a kinematic viscosity (ASTM D445) before dimerization of about 4 cSt or less at 135° C.

Embodiment 11. The adhesive composition of Embodiment 10, wherein the diluent comprises at least one of the one or more LAO dimers or the one or more paraffinic hydrocarbons.

Embodiment 12. The adhesive composition of Embodiment 10 or Embodiment 11, wherein the one or more C₁₈₊ LAOs comprise predominantly C₂₀-C₂₄ LAOs, or C₂₄₊ LAOs.

Embodiment 13. The adhesive composition of any one of Embodiments 10-12, wherein the one or more C₁₈₊ LAOs have a kinematic viscosity (ASTM D445) of about 1 cSt to about 4 cSt at 135° C.

Embodiment 14. The adhesive composition of any one of Embodiments 10-12, wherein the one or more LAO dimers have a kinematic viscosity (ASTM D445) of about 4 cSt to about 5.5 cSt at 135° C.

Embodiment 15. The adhesive composition of any one of Embodiments 10-12, wherein the one or more paraffinic hydrocarbons formed through dimerization of one or more C₁₈₊ LAOs and subsequent reduction have a kinematic viscosity (ASTM D445) of about 4 cSt to about 8 cSt at 135° C.

Embodiment 16. An adhesive composition comprising:
a styrenic block copolymer;
a tackifier; and
a diluent comprising at least one of:
   one or more C₁₈₊ linear alpha olefins (LAOs) having a kinematic viscosity (ASTM D445) of about 4 cSt or less at 135° C.;
   one or more LAO dimers formed from one or more C₁₈₊ LAOs, the one or more LAO dimers having an internal olefin and a kinematic viscosity (ASTM D445) of about 6 cSt or less at 135° C.; or one or more paraffinic hydrocarbons having an even carbon number distribution and formed through dimerization of one or more C₁₈₊ LAOs and subsequent reduction, the one or more C₁₈₊ LAOs having a kinematic viscosity (ASTM D445) before dimerization of about 4 cSt or less at 135° C.

Embodiment 17. The adhesive composition of Embodiment 16, wherein the styrenic block copolymer comprises styrene-butadiene-styrene, styrene-isoprene-styrene, styrene-ethylene-butylene-styrene, any copolymer thereof, and any combination thereof.

Embodiment 18. The adhesive composition of Embodiment 16 or Embodiment 17, wherein the diluent comprises at least one of the one or more LAO dimers or the one or more paraffinic hydrocarbons.

Embodiment 19. The adhesive composition of any one of Embodiments 16-18, wherein the one or more C₁₈₊ LAOs comprise predominantly C₂₀-C₂₄ LAOs, or C₂₄₊ LAOs.

Embodiment 20. The adhesive composition of any one of Embodiments 16-19, wherein the one or more C₁₈₊ LAOs have a kinematic viscosity (ASTM D445) of about 1 cSt to about 4 cSt at 135° C.

Embodiment 21. The adhesive composition of any one of Embodiments 16-19, wherein the one or more LAO dimers have a kinematic viscosity (ASTM D445) of about 4 cSt to about 5.5 cSt at 135° C.

Embodiment 22. The adhesive composition of any one of Embodiments 16-19, wherein the one or more paraffinic hydrocarbons formed through dimerization of one or more C₁₈₊ LAOs and subsequent reduction have a kinematic viscosity (ASTM D445) of about 4 cSt to about 8 cSt at 135° C.

Embodiment 23. The adhesive composition of any one of Embodiments 16-22, wherein the styrenic block copolymer comprises about 40 wt. % or less of the adhesive composition.

To facilitate a better understanding of the embodiments of the present disclosure, the following examples of preferred or representative embodiments are given. In no way should the following examples be read to limit, or to define, the scope of the invention.

### EXAMPLES

PARVAN™ 1580 is a high-melting paraffin wax available from ExxonMobil Chemical Company. PRIMOL™ 352 is a white mineral oil containing approximately a 2:1 ratio of paraffinic hydrocarbons:naphthenic hydrocarbons available from ExxonMobil Chemical Company. NYFLEX™ 223 is a hydrotreated mineral oil containing approximately 55% paraffinic hydrocarbons, 43% naphthenic hydrocarbons, and 2% aromatic hydrocarbons available from Nynas. SASOLWAX™ H1 Fischer-Tropsch hard wax and SASOLWAX C80 Fischer-Tropsch wax were obtained from Sasol.

NEODENE™ 2024 (Shell Oil Company) was used as a source of LAOs (base product is predominantly C₂₀-C₂₄ LAOs and <7% Cis. LAOs). C₁₈-C₂₄ and C₂₄₊ LAO fractions were obtained through fractional distillation as overhead and bottoms fractions, respectively. LAO dimerization was conducted by metathesis through exposure of a specified LAO fraction to a metal carbene catalyst, as described hereinafter. LAO dimers were catalytically hydrogenated to the corresponding paraffinic hydrocarbons, as described hereinafter.

A 1-gallon continuous stirred-tank reactor (CSTR) made of SS316 low carbon stainless steel was used as the metathesis reactor. Prior to use, the reactor was thoroughly flushed and cleaned with dewatered toluene and then flushed with purified LAOs. The reactor was subsequently passivated with hot toluene at about 95° C. by circulating the hot toluene through the system for about 4 to 5 hours. The LAO feeds were degassed inline using vacuum to remove any remaining dissolved gasses. The LAO feeds were further purified by passage through a hybrid adsorbent bed of AZ-300 molecular sieves (Honeywell—UOP) for impurity removal (e.g., sulfur, oxygen, ethylene, peroxides, and other heteroatoms). The AZ-300 was pre-activated under N₂ at 250° C. for about 8 hours prior to use.

Olefin metathesis was conducted in the presence of a metal carbene catalyst such as Grubbs Catalyst™ 2nd Generation (Gr II) (MW=849 g/mol), Hoveyda-Grubbs Catalyst™ 2nd Generation (HGr II) (MW=627 g/mol), or Schrock Mo carbene catalyst. The metal carbene catalysts were used either in solution (previously dissolved in toluene), as a dry powder, or as a slurry mixed with SPECTRASYN™ 4, a polyalphaolefin synthetic basestock (ExxonMobil Chemicals), also referred to as a Group IV base oil according to the API Base Oil Classification system, without any prior activation process. Homogeneous catalyst solutions were prepared in a glove box under N₂ at room temperature by dissolving the metal carbene catalyst (initially in a powder form) in purified, dewatered toluene. The catalyst solutions were protected from moisture and stored at about 4° C. in a refrigerator. Catalyst suspensions were also prepared using, for example, the metal carbene catalyst powder dispersed in a low viscosity polyalphaolefin (e.g., viscosity of 2-10 cSt, such as 2, 4 or 6 cSt), or a hydrogenated olefin dimer, such as, for example, a hydrogenated C₂₆ dimer (prepared from a C₁₄ LAO via a metathesis reaction according to the disclosure herein, followed by hydrogenation). Aromatic solvents, such as toluene, may be excluded from the reaction by using a polyalphaolefin catalyst dispersant.

The catalyst solution in toluene was delivered sub-surface to the reactor via a dip tube using a dedicated metering pump. The catalyst solution was stirred continuously in a separate vessel prior to delivery. Reactions were conducted at a temperature of about 60° C. to about 75° C. at a pressure of about 10-25 psi. The reaction temperature was usually limited to about 60° C. to about 65° C. to limit double bond migration.

Ethylene produced during the metathesis reaction was removed from the reactor while continuing to form dimer. Ethylene removal was accomplished with N₂ sparging at a rate of about 2-3 L/min. Any remaining transition metal residues and catalyst debris present in the finished product were removed using silica, Celite®, or other filtration media. Unconverted monomers and other light products were removed by distillation of the reactor effluent to afford purified linear olefin dimers.

The corresponding paraffinic hydrocarbons were formed by slurry hydrogenation under the following hydrogenation conditions: 0.5 wt. % Ni powder catalyst, temperature=230′° C., pressure=300 psig (20.68 barg) and 1-2 hours of contact time. After hydrogenation, the Ni catalyst was removed by filtration. Hydrogenation also may be conducted using a heterogeneous Ni or Pt catalysis, or in a batch autoclave reactor using a heterogeneous Pd on carbon catalyst.

Table 1 summarizes the physical properties of various diluents, either commercial or formed in accordance with the disclosure above, used in formulating hot melt adhesives in the disclosure herein.

TABLE 1

| | | | Kinematic | Kinematic | Average |
|---|---|---|---|---|---|
| | Congealing | Melting | Viscosity | Viscosity | Molecular |
| | point | Point | at 135° C. | at 100° C. | Weight |
| | (° C.) | (° C.) | (cSt) | (cSt) | (Mn) |
| | ASTM Test Method | | | | |
| Sample | D938 | D87 | D445 | D445 | (GPC) |
| PARVAN ™ 1580 | 70 | 71 | 4.3 | 7.5 | 513 |
| SASOLWAX H1 | 97 | 112 | 12 | — | 995 |
| Fischer-Tropsch | | | | | |
| wax | | | | | |
| C₂₀-C₂₄ LAOs | 30 | 30 | 1.0 | 2.0 | 294 |
| (90% C₂₀/C₂₂ | | | | | |
| LAOs) | | | | | |
| C₂₄₊ LAOs | 61 | 64 | 3.7 | 4.0 | 419 |
| (56% C₂₄/C₂₆/C₂₈ | | | | | |
| LAOs) | | | | | |
| C₃₄-C₄₆ LAO | 57 | 58 | 4.0 | 6.3 | 584 |
| dimers obtained | | | | | |
| from C₁₈-C₂₄ | | | | | |
| LAOs | | | | | |
| C₃₄-C₄₆ paraffins | 76 | 78 | 4.2 | 6.8 | 554 |
| obtained from C₁₈- | | | | | |
| C₂₄ LAOs via | | | | | |
| dimerization and | | | | | |
| hydrogenation | | | | | |
| C₄₆₊ LAO dimers | 78 | 80 | 5.2 | 9.7 | 1028 |
| obtained from C₂₄₊ | | | | | |
| LAOs | | | | | |
| C₄₆₊ paraffins | 90 | 88 | 7.5 | 14.8 | 994 |
| obtained from C₄₆₊ | | | | | |
| LAOs via | | | | | |
| dimerization and | | | | | |
| hydrogenation | | | | | |

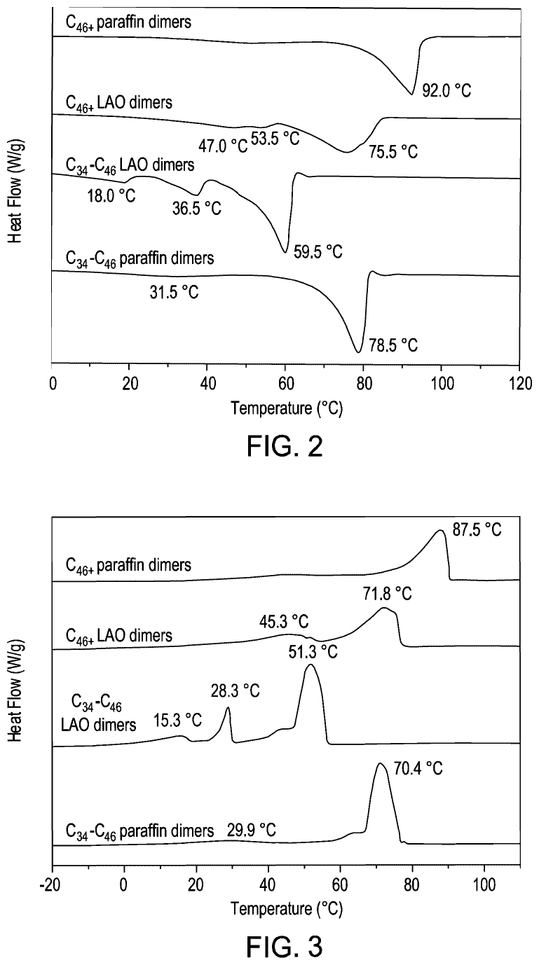

FIGS. 2 and 3 are overlay plots of differential scanning calorimetry (DSC) endothermic melting peaks and exothermic crystallization peaks, respectively, for LAO dimers and paraffinic hydrocarbons derived from LAO dimers specified in Table 1. As shown, the LAO dimers containing an internal olefin exhibited thermal transitions at slightly lower temperatures than did the corresponding dimer-derived paraffins. The thermal transitions for the C₃₄-C₄₆ paraffins obtained from C₁₈-C₂₄ LAOs and the C₄₆₊ LAO dimers obtained from C₂₄₊ LAOs exhibited their thermal transitions at approximately the same temperature.

### Hot Melt Adhesive Compositions

Hot melt adhesive compositions were prepared as described in U.S. Pat. Nos. 10,633,565 and 10,336,921, each incorporated herein by reference. In brief, a blend mixture was heated and stirred at 177° C. until all components were melted. The molten blend was then poured onto release paper. After cooling, the solidified blend was cut into small pieces for testing. Comparative and experimental hot melt adhesives were formulated as specified below in Table 2 (PP, SBS and SIS formulations), Table 4 (1-butene/propylene formulations) and Table 5 (PE and EVA formulations).

### PP, SBS and SIS Hot Melt Adhesives

Hot melt adhesives formulated with polypropylene (PP), styrene-isoprene-styrene (SIS), or styrene-butadiene-styrene (SBS) were formulated as specified in Table 2. All samples also contained 1 wt. % IRGANOX 1010 antioxidant (not shown in Table 2).

TABLE 2

| | | | | | Viscosity |
|---|---|---|---|---|---|
| | | | | | (ASTM D-3236@ |
| | Polymer | Tackifier | Wax | Oil | specified |
| Sample | [Wt. % of | [Wt. % of | [Wt. % of | [Wt. % of | temperature) |
| Number | Total] | Total] | Total] | Total] | [% Decrease] |
| 1A | isotactic PP^{a} | cycloaliphatic | — | PRIMOL | 10600 cP/ |
| (Comp.) | [65%] | hydrocarbon | | 352 | 140° C. |
| | | resin^{b} | | [10%] | |
| | | [24%] | | | |
| 1B | isotactic PP^{a} | cycloaliphatic | C₂₄₊ LAOs | — | 6175 cP/ |
| (Exp.) | [65%] | hydrocarbon | [10%] | | 140° C. |
| | | resin^{b} | | | [41.75%] |
| | | [24%] | | | |
| 2A | isotactic PP^{c} | cycloaliphatic | | PRIMOL | 6265 cP/ |
| (Comp.) | [70%] | hydrocarbon | | 352 | 140° C. |
| | | resin^{b} | | [10%] | |
| | | [20%] | | | |
| 2B | isotactic PP^{c} | cycloaliphatic | PARVAN | — | 5250 cP/ |
| (Comp.) | [70%] | hydrocarbon | 1471 | | 140° C. |
| | | resin^{b} | [10%] | | |
| | | [20%] | | | |
| 2C | isotactic PP^{c} | cycloaliphatic | C₂₄₊ LAOs | — | 5387 cP/ |
| (Exp.) | [70%] | hydrocarbon | [10%] | | 140° C. |
| | | resin^{b} | | | [14.01%] |
| | | [20%] | | | |
| 2C | isotactic PP^{c} | cycloaliphatic | C₂₄₊ LAOs | — | 7510 cP/ |
| (Exp.) | [73%] | hydrocarbon | [5%] | | 140° C. |
| | | resin^{b} | | | |
| | | [21%] | | | |
| 3A | isotactic PP^{c} | cycloaliphatic | — | PRIMOL | 6925 cP/ |
| (Comp.) | [70%] | hydrocarbon | | 352 | 140° C. |
| | | resin^{b} | | [10%] | |
| | | [20%] | | | |
| 3B | isotactic PP^{c} | cycloaliphatic | C₃₄-C₄₆ | — | 5338 cP/ |
| (Exp.) | [70%] | hydrocarbon | paraffins | | 140° C. |
| | | resin^{b} | obtained from | | [22.92%] |
| | | [20%] | C₁₈-C₂₄ LAOs | | |
| | | | [10%] | | |
| 4A | isotactic PP^{c} | cycloaliphatic | SASOLWAX | — | 6400 cP/ |
| (Comp.) | [70%] | hydrocarbon | H1 | | 140° C. |
| | | resin^{b} | [10%] | | |
| | | [20%] | | | |
| 4B | isotactic PP^{c} | cycloaliphatic | C₃₄-C₄₆ | — | 5338 cP/ |
| (Exp.) | [70%] | hydrocarbon | paraffins | | 140° C. |
| | | resin^{b} | obtained from | | [16.59%] |
| | | [20%] | C₁₈-C₂₄ LAOs | | |
| | | | [10%] | | |
| 5A | SIS^{d} | cycloaliphatic | — | NYFLEX | 1023 cP/ |
| (Comp.) | [20%] | hydrocarbon | | 223 | 160° C. |
| | | resin^{b} | | [20%] | |
| | | [60%] | | | |
| 5B | SIS^{d} | cycloaliphatic | C₂₄₊ LAOs | NYFLEX | 840 cP/ |
| (Exp.) | [20%] | hydrocarbon | [10%] | 223 | 160° C. |
| | | resin^{b} | | [10%] | [17.89%] |
| | | [60%] | | | |
| 6A | SBS^{e} | cycloaliphatic | — | NYFLEX | 3405 cP/ |
| (Comp.) | [20%] | hydrocarbon | | 223 | 160° C. |
| | | resin^{f} | | [20%] | |
| | | [60%] | | | |
| 6B | SBS^{e} | cycloaliphatic | C₂₀-C₂₄ LAOs | NYFLEX | 2295 cP/ |
| (Exp.) | [20%] | hydrocarbon | [10%] | 223 | 160° C. |
| | | resin^{f} | | [10%] | [32.60%] |
| | | [60%] | | | |
| 7A | isotactic PP^{a} | cycloaliphatic | — | PRIMOL | 7408 cP/ |
| (Comp.) | [60%] | hydrocarbon | | 352 | 140° C. |
| | | resin^{b} | | [15%] | |
| | | [24.5%] | | | |
| 7B | isotactic PP^{a} | cycloaliphatic | PARVAN | — | 5650 cP/ |
| (Comp.) | [60%] | hydrocarbon | 1471 | | 140° C. |
| | | resin^{b} | [15%] | | [23.8%] |
| | | [24.5%] | | | |
| 7C | isotactic PP^{a} | cycloaliphatic | SASOLWAX | — | 6825 cP/ |
| (Comp.) | [60%] | hydrocarbon | H1 | | 140° C. |
| | | resin^{b} | [15%] | — | [7.87%] |
| | | [24.5%] | | | |
| 7D | isotactic PP^{a} | cycloaliphatic | C₃₄-C₄₆ | — | 5983 cP/ |
| (Exp.) | [60%] | hydrocarbon | paraffins | | 140° C. |
| | | resin^{b} | obtained from | | [19.24%] |
| | | [24.5%] | C₁₈-C₂₄ LAOs | | |
| | | | [15%] | | |

^{a}VISTAMAXX 8380 (ExxonMobil)
^{b}ESCOREZ 5400 (ExxonMobil)
^{c}VISTAMAXX 8780 (ExxonMobil)
^{d}VECTOR 4211 (TSRC Specialty Materials)
^{e}VECTOR 8508 (TSRC Specialty Materials)
^{f}ESCOREZ 5600 (ExxonMobil)

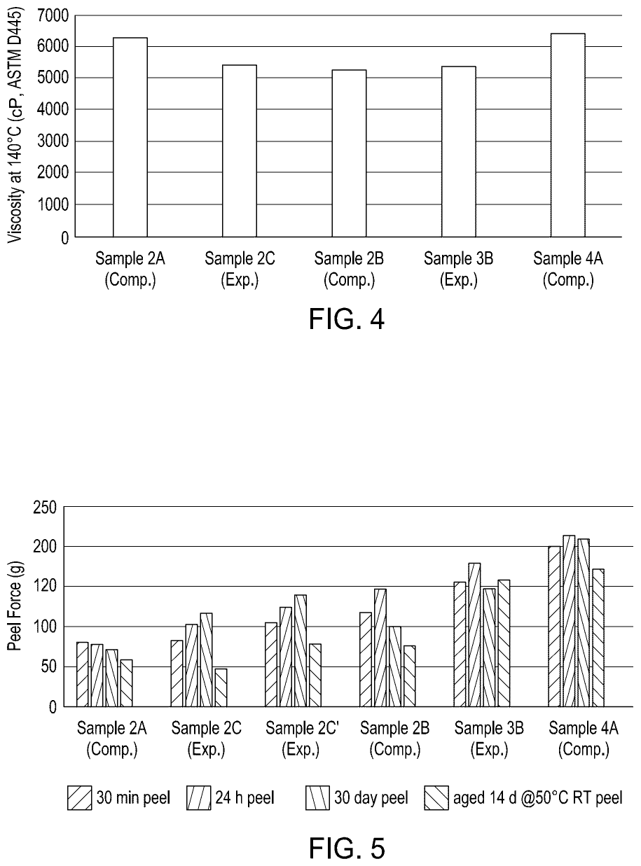

FIG. 4 is a bar graph showing a comparison of Brookfield viscosity values (ASTM D-3236) at 140° C. for several polyolefin-based hot melt adhesive compositions (Samples 2A-2C, 3B and 4A). As shown, the samples containing white oil (Sample 2A) and Fischer-Tropsch wax (Sample 4A) exhibited higher viscosity values than did the samples containing a comparable amount of LAOs or paraffinic hydrocarbons derived from LAOs.

### T-Peel Strength.

Samples 1A, 1B, 2A, 2B, 2C, 2C′, 3B and 4A were coated onto a polyethylene backsheet film and laminated onto a polypropylene nonwoven fabric in a moving process line at 250 m/min. The hot melt adhesive was applied to the polyethylene backsheet film at a temperature of 140° C. The T-peel adhesion force was measured 30 minutes after exiting the process line, after 24 hours, and after 30 days. Additional samples were force aged for 14 days at 50° C., and the T-peel adhesion force was then tested. Peel or peel strength is a measure of the average force needed to pull apart two bonded materials and was tested in a T-peel fashion on a slip/peel tester from IMASS Inc. at 12 in/min, as determined according to ASTM D-903. Tables 3A and 3B show the T-peel adhesion force for the tested samples under each set of conditions.

TABLE 3A

| | Sample | Sample | Sample | Sample | Sample | Sample |
|---|---|---|---|---|---|---|
| | 1A | 1B | 2A | 2C | 2C′ | 3B |
| 30 minute T- | 115 | 130 | 80 | 83 | 105 | 266 |
| peel force (g) | | | | | | |
| 24 hour T- | 104 | 130 | 78 | 102 | 124 | 178 |
| peel force (g) | | | | | | |
| 30 day T- | 108 | 119 | 71 | 116 | 140 | 147 |
| peel force (g) | | | | | | |
| T-peel force | 90 | 42 | 59 | 47 | 79 | 158 |
| after forced | | | | | | |
| aging (g) | | | | | | |

TABLE 3B

| | Sample | Sample | Sample | Sample |
|---|---|---|---|---|
| | 7A | 7B | 7C | 7D |
| 30 minute T-peel | 118 | 45 | Not | 233 |
| force (g) | | | tested | |
| 24 hour T-peel | 138 | 72 | 189 | 278 |
| force (g | | | | |
| 30 day T-peel | 101 | 124 | 184 | 250 |
| force (g) | | | | |
| T-peel force after | 97 | 114 | 161 | 283 |
| forced aging (g) | | | | |

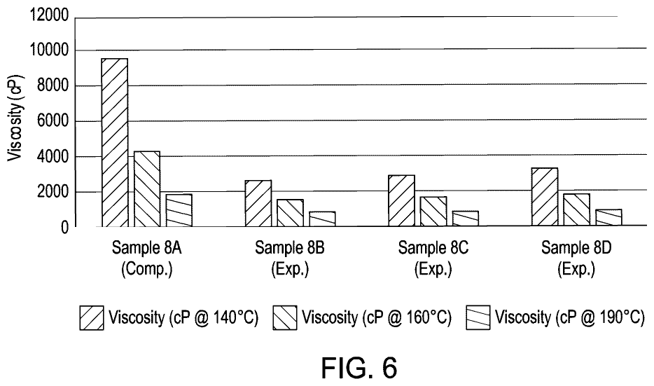

As shown, C₂₄₊ LAOs maintained or somewhat improved the peel adhesion performance compared to a paraffinic white oil alone (comparing Sample 1A against Sample 1B and Sample 2A against Sample 2C), except for the value obtained following forced aging in both cases. A slight modification of Sample 2C improved the peel adhesion performance still further (Sample 2C′) and also increased the forced aging value above the reference value. Notably, the viscosity of Sample 2C was considerably lower than that of Sample 2A. The increased peel strength in combination with the decreased viscosity value for Sample 2C was particularly surprising, given the lower molecular weight of the C₂₄₊ LAOs compared to that of the paraffinic white oil (Table 1). Namely, the much lower molecular weight of the C₂₄₊ LAOs in comparison to the paraffinic white oil would be expected to decrease the peel strength, whereas the opposite effect was realized in practice. Sample 3B, containing the C₂₄₊ LAO-derived paraffinic hydrocarbons as a diluent, exhibited significantly increased peel strength values under all tested conditions but without undergoing an appreciable increase in viscosity. The increased peel strength of Sample 3B in the absence of a concurrent increase in viscosity was particularly surprising, given the near-doubling of the molecular weight of the paraffinic diluent compared to the parent C₂₄₊ LAOs (Table 1). Sample 4A, containing SASOLWAX H1 with a comparable molecular weight to that of the C₂₄₊ LAO-derived paraffinic hydrocarbons, afforded a still higher peel strength, but at the expense of a higher viscosity. The different viscosity values may arise from compatibility variation of the two waxes with the hot melt adhesive compositions. Sample 7D likewise emphasizes the improved T-peel strength performance afforded by paraffins produced from C₂₄₊ LAO dimers in comparison to other paraffinic diluents (Samples 7A-7C). FIG. 5 is a bar graph summarizing T-peel adhesion force performance (ASTM D-903) for Samples 2A, 2C, 2C′, 2B, 3B, and 4A at 30 minutes, 24 hours, 30 days, and following forced aging conditions.

### 1-Butene/Propylene Hot Melt Adhesives

A comparative hot melt adhesive composition based upon 1-butene/propylene copolymer (REXTAC 2730, Rextac) was formulated at 70 wt. % with 30 wt. % ESCOREZ 5320 tackifier (ExxonMobil) under the general conditions specified above. Experimental hot melt adhesive compositions were then prepared under similar conditions by replacing half of the ESCOREZ 5320 tackifier with C₂₀-C₂₄ LAOs, C₂₄₊ LAOs, or paraffinic hydrocarbons obtained from C₂₀-C₂₄ LAOs. The hot melt adhesive compositions are further specified in Table 4 below.

TABLE 4

| | Polymer | Tackifier | Wax |
|---|---|---|---|
| Sample | [Wt. % of | [Wt. % of | [Wt. % of |
| Number | Total] | Total] | Total] |
| 8A | 1-butene/ | cycloaliphatic | |
| (Comp.) | propylene^{a} | hydrocarbon | |
| | [70%] | resin | |
| | | [30%] | |
| 8B | 1-butene/ | cycloaliphatic | C₂₀-C₂₄ |
| (Exp.) | propylene^{a} | hydrocarbon | LAOs |
| | [70%] | resin^{b} | [15%] |
| | | [15%] | |
| 8C | 1-butene/ | cycloaliphatic | C₂₄₊ LAOs |
| (Exp.) | propylene^{a} | hydrocarbon | [15%] |
| | [70%] | resin^{b} | |
| | | [15%] | |
| 8D | 1-butene/ | cycloaliphatic | C₃₄-C₄₆ |
| (Exp.) | propylene^{a} | hydrocarbon | paraffins |
| | [70%] | resin^{b} | obtained |
| | | [15%] | from C₁₈- |
| | | | C₂₄ LAOs |
| | | | [15%] |

^{a}REXTAC 2730
^{b}ESCOREZ 5320

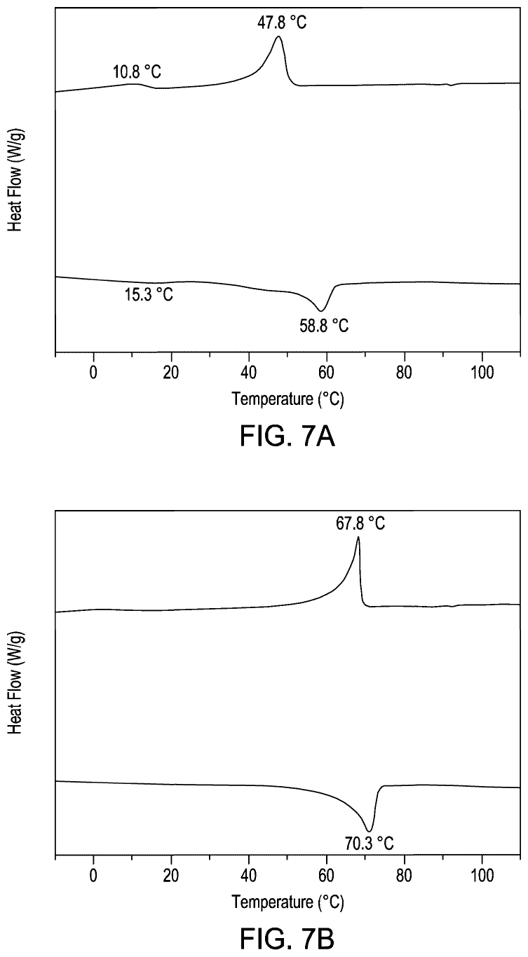

The Brookfield viscosity of each hot melt adhesive was measured at 140° C., 160° C. and 190° C. FIG. 6 is a bar graph of Brookfield viscosity (ASTM D-3236) for Samples 8A-8D at various temperatures. As shown, by replacing a portion of the tackifier with a LAO-derived wax, a significant decrease in viscosity was realized in each case, particularly in the 140° C.-160° C. range to facilitate low-temperature applications in comparison to the reference formulation (Sample 8A). Only a slight increase in viscosity was observed for the sample containing the paraffinic hydrocarbons (Sample 8D) in comparison to those containing LAOs (Samples 8B and 8C).

### PE and EVA Hot Melt Adhesives

Hot melt adhesives containing polyethylene (PE) and ethylene-vinyl acetate (EVA) were formulated as specified in Table 5 below.

TABLE 5

| | | | | Viscosity | |
|---|---|---|---|---|---|
| | Polymer | Tackifier | Wax | (ASTM | |
| Sample | [Wt. % of | [Wt. % of | [Wt. % of | D-3236 | |
| Number | Total] | Total] | Total] | @ 175° C.) | |
| 9 | | | | 845 | cP |
| (Commercial | | | | | |
| Reference, | | | | | |
| ADVANTA | | | | | |
| 9256) | | | | | |
| 10 | PE^{a} | cycloaliphatic | SASOLWAX | 1122 | cP |
| (Comp.) | [40%] | hydrocarbon | H1 | | |
| | | resin^{b} | [25%] | | |
| | | [34.5%] | | | |
| 11 | PE^{a} | hydrocarbon | SASOLWAX | 953 | cP |
| (Comp.) | [40%] | resin^{b} | C80 | | |
| | | [34.5%] | [25%] | | |
| 12 | PE^{a} | cycloaliphatic | C₃₄-C₄₆ LAO | 820 | cP |
| (Exp.) | [41%] | hydrocarbon | dimers | | |
| | | resin^{b} | obtained | | |
| | | [38.5%] | from C₁₈-C₂₄ | | |
| | | | LAOS | | |
| | | | [20%] | | |
| 13 | PE^{a} | cycloaliphatic | C₃₄-C₄₆ | 903 | cP |
| (Exp.) | [41%] | hydrocarbon | paraffins | | |
| | | resin^{b} | obtained | | |
| | | [38.5%] | from C₁₈-C₂₄ | | |
| | | | LAOS | | |
| | | | [20%] | | |
| 14 | PE^{a} | cycloaliphatic | C₄₆₊ LAO | 975 | cP |
| (Exp.) | [41%] | hydrocarbon | dimers | | |
| | | resin^{b} | obtained | | |
| | | [38.5%] | from C₂₄₊ | | |
| | | | LAOs | | |
| | | | [20%] | | |
| 15 | PE^{a} | cycloaliphatic | C₄₆₊ paraffins | 1060 | cP |
| (Exp.) | [40%] | hydrocarbon | obtained | | |
| | | resin^{b} | from C₂₄₊ | | |
| | | [40%] | LAOs | | |
| | | | [20%] | | |
| 16 | EVA^{d} | cycloaliphatic | SASOLWAX | 1107 | cP |
| (Comp.) | [41%] | hydrocarbon | H1 | | |
| | | resin^{c} | [20%] | | |
| | | [38.5%] | | | |
| 17 | EVA^{d} | cycloaliphatic | SASOLWAX | 976 | cP |
| (Comp.) | [41%] | hydrocarbon | C80 | | |
| | | resin^{c} | [20%] | | |
| | | [38.5%] | | | |
| 18 | EVA^{d} | cycloaliphatic | C₃₄-C₄₆ LAO | 836 | cP |
| (Exp.) | [40%] | hydrocarbon | dimers | | |
| | | resin^{c} | obtained | | |
| | | [40%] | from C₁₈-C₂₄ | | |
| | | | LAOS | | |
| | | | [20%] | | |
| 19 | EVA^{d} | cycloaliphatic | C₃₄-C₄₆ | 951 | cP |
| (Exp.) | [40%] | hydrocarbon | paraffins | | |
| | | resin^{c} | obtained | | |
| | | [40%] | from C₁₈-C₂₄ | | |
| | | | LAOs | | |
| | | | [20%] | | |
| 20 | EVA^{d} | cycloaliphatic | C₄₆₊ LAO | 947 | cP |
| (Exp.) | [40%] | hydrocarbon | dimers | | |
| | | resin^{c} | obtained | | |
| | | [40%] | from C₂₄₊ | | |
| | | | LAOS | | |
| | | | [20%] | | |
| 21 | EVA^{d} | cycloaliphatic | C₄₆₊ paraffins | 1055 | cP |
| (Exp.) | [40%] | hydrocarbon | obtained | | |
| | | resin^{c} | from C₂₄₊ | | |
| | | [40%] | LAOS | | |
| | | | [20%] | | |

^{a}AFFINITY 1950 (Dow) (ethylene-octene copolymer)
^{b}ESCOREZ 5600 (ExxonMobil)
^{c}ESCOREZ 5637 (ExxonMobil)
^{d}ESCORENE UL7710 (ExxonMobil)

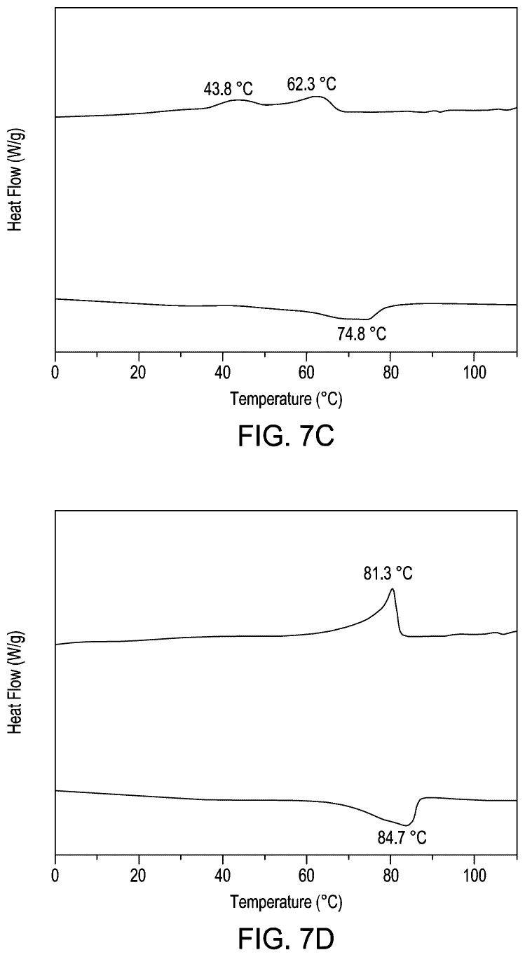

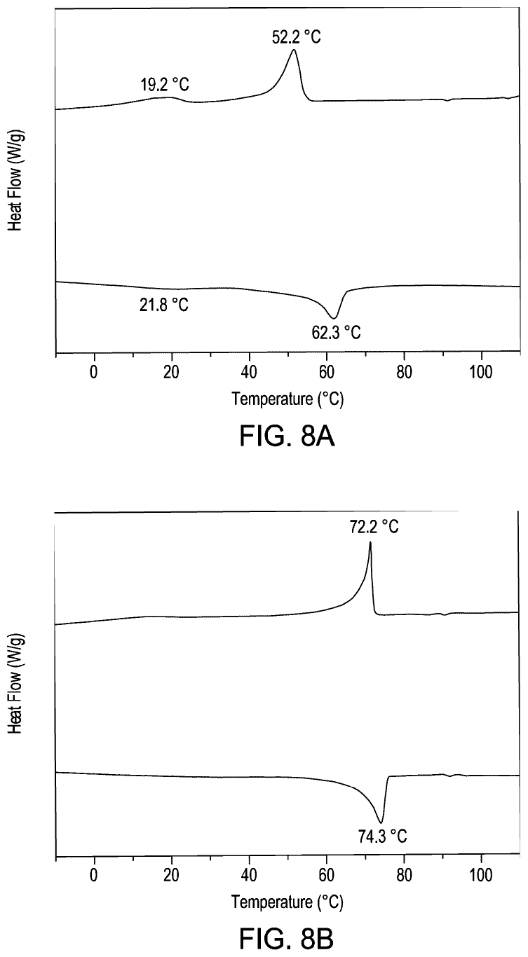

FIGS. 7A-7D are combined DSC plots of endothermic melting peaks and exothermic crystallization peaks for Samples 12-15 (experimental PE-based hot melt adhesives). FIGS. 8A-8D are combined DSC plots of endothermic melting peaks and exothermic crystallization peaks for Samples 18-21 (experimental EVA-based hot melt adhesives). In most cases, the thermal transitions shifted to a lower temperature when formulated in a hot melt adhesive relative to those exhibited by the neat LAO-derived diluents (FIGS. 2A and 2B). The relative ordering of the transition temperatures was maintained from that of the neat LAO-derived diluents. The thermal transitions for the EVA system were approximately 4-5° C. higher than those observed in the PE system. The relatively sharp and narrow transitions, especially for the paraffinic diluents, may be advantageous for promoting short set times during adhesive applications.

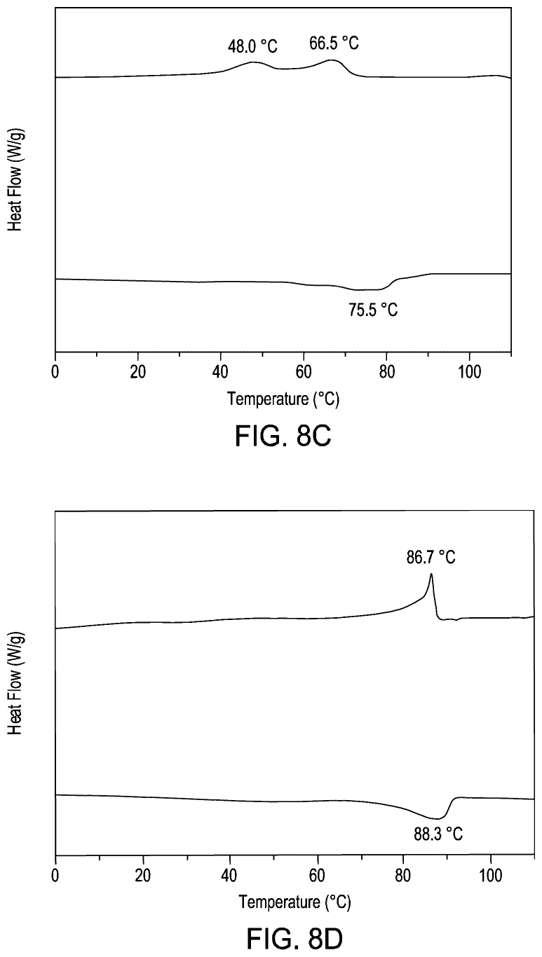

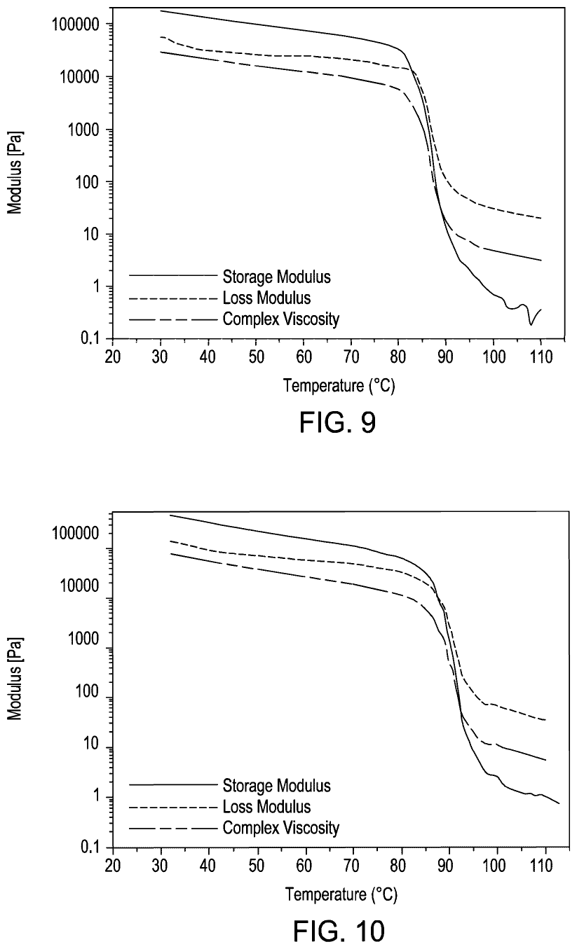

FIG. 9 is a plot of complex rheology for Sample 15, and FIG. 10 is a plot of complex rheology for Sample 21. As shown, the viscosity changed rapidly close to the thermal transition temperatures. Other samples exhibited similar behavior. In addition, the viscosity change as function of temperature was more rapid (steeper) for the samples containing paraffinic LAO-derived diluents in comparison to those containing olefinic LAO-derived diluents (data not shown).

Table 6 below summarizes various performance parameters for selected hot melt adhesive compositions from Table 5. For aged fiber tear testing, the samples were stored at −18° C. for three months and then tested at room temperature (RT).

TABLE 6

| | Sample | Sample | Sample | Sample | Sample | Sample | Sample | Sample | Sample |
|---|---|---|---|---|---|---|---|---|---|
| | 9 | 10 | 11 | 13 | 15 | 16 | 17 | 19 | 21 |
| | (Ref.) | (Comp.) | (Comp.) | (Exp.) | (Exp.) | (Comp.) | (Comp.) | (Exp.) | (Exp.) |
| % Fiber Tear | 50 | 40 | 20 | 65 | 0 | 70 | 70 | 80 | 65 |
| (2° C.) | | | | | | | | | |
| % Fiber Tear | 70 | 80 | 70 | 50 | 80 | 75 | 55 | 70 | 65 |
| (RT) | | | | | | | | | |
| % Fiber Tear | 95 | 75 | 50 | 50 | 11 | 85 | 85 | 90 | 75 |
| (−18° C.) | | | | | | | | | |
| Aged Fiber | 95 | 90 | 55 | 85 | 90 | 95 | 85 | 90 | 90 |
| Tear (%) | | | | | | | | | |
| Shear | 88.5 | 88 | 76.5 | 82.4 | 70.7 | 82.3 | 75.3 | 79.8 | 69.7 |
| adhesion | | | | | | | | | |
| fiber tear | | | | | | | | | |
| failure (° C.) | | | | | | | | | |
| Peel adhesion | 59.3 | 60.6 | 58.3 | 45.8 | 32.8 | 55.5 | 51.0 | 46.0 | 38.7 |
| fiber tear | | | | | | | | | |
| failure (° C.) | | | | | | | | | |
| Tensile force | 2.62 | 3.02 | 2.85 | 1.87 | 1.96 | 2.92 | 2.77 | 2.02 | 1.99 |
| (Pa, 100%) | | | | | | | | | |
| Tensile force | 3.96 | 3.58 | 3.08 | 2.31 | 2.21 | 3.55 | 2.93 | 2.40 | 2.14 |
| (Pa, @ tensile | | | | | | | | | |
| strength) | | | | | | | | | |
| Tensile | 8 | 18 | 46 | 25 | 42 | 13 | 46 | 22 | 41 |
| elongation | | | | | | | | | |
| (%, @ tensile | | | | | | | | | |
| strength) | | | | | | | | | |
| Tensile force | 1.37 | 1.68 | 1.97 | 1.24 | 1.35 | 2.64 | 2.34 | 1.54 | 1.35 |
| (Pa, @ break) | | | | | | | | | |
| Tensile | 202 | 188 | 172 | 124 | 121 | 657 | 401 | 362 | 185 |
| elongation | | | | | | | | | |
| (%, @ break) | | | | | | | | | |
| T_{c} (° C., DSC) | 93.8 | 91.8 | 74.3 | 81.3 | 68.6 | 92.1 | 73.8 | 82.5 | 67.3 |
| Tₘ (° C., DSC) | 108.8 | 105.6 | 80.1 | 89.3 | 75.2 | 107.3 | 78.3 | 82.5 | 67.3 |
| Sample | 1.878 | 1.779 | 1.856 | 1.821 | 1.860 | 1.817 | 1.836 | 1.789 | 1.840 |
| Thickness | | | | | | | | | |
| (mm) | | | | | | | | | |

Many alterations, modifications, and variations will be apparent to one having ordinary skill in the art in light of the foregoing description without departing from the spirit or scope of the present disclosure and that when numerical limits and numerical upper limits are listed herein, ranges from any lower limit to any upper limit are contemplated.

All documents described herein are incorporated by reference herein for purposes of all jurisdictions where such practice is allowed, including any priority documents and/or testing procedures to the extent that they are not inconsistent with this text. As is apparent from the foregoing general description and the specific embodiments, while forms of the disclosure have been illustrated and described, various modifications may be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is:

1. An adhesive composition comprising:
an ethylenically unsaturated polymer or copolymer;
a tackifier; and
a diluent comprising at least one of:
one or more LAO dimers formed from one or more C₁₈₊ LAOs, the one or more LAO dimers having an internal olefin and a kinematic viscosity (ASTM D-445) of about 6 cSt or less at 135° C.; or
one or more paraffinic hydrocarbons having an even carbon number distribution and formed through dimerization of one or more C₁₈₊ LAOs and subsequent reduction, the one or more C₁₈₊ LAOs having a kinematic viscosity (ASTM D-445) before dimerization of about 4 cSt or less at 135° C.

2. The adhesive composition of claim 1, wherein the ethylenically unsaturated polymer or copolymer comprises at least one polymer selected from the group consisting of polyethylene, polypropylene, ethylene-vinyl acetate, a styrenic block copolymer, any copolymer thereof, and any combination thereof.

3. The adhesive composition of claim 2, wherein the styrenic block copolymer comprises styrene-butadiene-styrene, styrene-isoprene-styrene, styrene-ethylene-butylene-styrene, any copolymer thereof, and any combination thereof.

4. The adhesive composition of claim 1, further comprising:
a paraffinic hydrocarbon oil, a paraffinic hydrocarbon wax, or any combination thereof.

5. The adhesive composition of claim 1, wherein the adhesive composition has a T-peel strength of about 100 g or greater at 1 day, as measured by ASTM D-903.

6. The adhesive composition of claim 1, wherein the adhesive composition has a Brookfield viscosity (ASTM D-3236) of about 8000 cP or lower at 140° C.

7. The adhesive composition of claim 1, wherein the one or more C₁₈₊ LAOs comprise predominantly C₂₀-C₂₄ LAOs, or C₂₄₊ LAOs.

8. The adhesive composition of claim 1, wherein the one or more LAO dimers have a kinematic viscosity (ASTM D-445) of about 4 cSt to about 5.5 cSt at 135° C.

9. The adhesive composition of claim 1, wherein the one or more paraffinic hydrocarbons formed through dimerization of one or more C₁₈₊ LAOs and subsequent reduction have a kinematic viscosity (ASTM D-445) of about 4 cSt to about 8 cSt at 135° C.

10. An adhesive composition comprising:
about 60 wt. % or above of a polypropylene polymer or copolymer;
a tackifier; and
a diluent comprising at least one of:
one or more C₁₈₊ linear alpha olefins (LAOs) having a kinematic viscosity (ASTM D-445) of about 4 cSt or less at 135° C.;
one or more LAO dimers formed from one or more C₁₈₊ LAOs, the one or more LAO dimers having an internal olefin and a kinematic viscosity (ASTM D-445) of about 6 cSt or less at 135° C.; or
one or more paraffinic hydrocarbons having an even carbon number distribution and formed through dimerization of one or more C₁₈₊ LAOs and subsequent reduction, the one or more C₁₈₊ LAOs having a kinematic viscosity (ASTM D-445) before dimerization of about 4 cSt or less at 135° C.

11. The adhesive composition of claim 10, wherein the diluent comprises at least one of the one or more LAO dimers or the one or more paraffinic hydrocarbons.

12. The adhesive composition of claim 10, wherein the one or more C₁₈₊ LAOs comprise predominantly C₂₀-C₂₄ LAOs, or C₂₄₊ LAOs.

13. The adhesive composition of claim 10, wherein the one or more C₁₈₊ LAOs have a kinematic viscosity (ASTM D-445) of about 1 cSt to about 4 cSt at 135° C.

14. The adhesive composition of claim 10, wherein the one or more LAO dimers have a kinematic viscosity (ASTM D-445) of about 4 cSt to about 5.5 cSt at 135° C.

15. The adhesive composition of claim 10, wherein the one or more paraffinic hydrocarbons formed through dimerization of one or more C₁₈₊ LAOs and subsequent reduction have a kinematic viscosity (ASTM D-445) of about 4 cSt to about 8 cSt at 135° C.

16. An adhesive composition comprising:
a styrenic block copolymer;
a tackifier; and
a diluent comprising at least one of:
one or more C₁₈₊ linear alpha olefins (LAOs) having a kinematic viscosity (ASTM D-445) of about 4 cSt or less at 135° C.;
one or more LAO dimers formed from one or more C₁₈₊ LAOs, the one or more LAO dimers having an internal olefin and a kinematic viscosity (ASTM D-445) of about 6 cSt or less at 135° C.; or
one or more paraffinic hydrocarbons having an even carbon number distribution and formed through dimerization of one or more C₁₈₊ LAOs and subsequent reduction, the one or more C₁₈₊ LAOs having a kinematic viscosity (ASTM D-445) before dimerization of about 4 cSt or less at 135° C.

17. The adhesive composition of claim 16, wherein the styrenic block copolymer comprises styrene-butadiene-styrene, styrene-isoprene-styrene, styrene-ethylene-butylene-styrene, any copolymer thereof, and any combination thereof.

18. The adhesive composition of claim 16, wherein the diluent comprises at least one of the one or more LAO dimers or the one or more paraffinic hydrocarbons.

19. The adhesive composition of claim 16, wherein the one or more C₁₈₊ LAOs comprise predominantly C₂₀-C₂₄ LAOs, or C₂₄₊ LAOs.

20. The adhesive composition of claim 16, wherein the one or more C₁₈₊ LAOs have a kinematic viscosity (ASTM D-445) of about 1 cSt to about 4 cSt at 135° C.

21. The adhesive composition of claim 16, wherein the one or more LAO dimers have a kinematic viscosity (ASTM D-445) of about 4 cSt to about 5.5 cSt at 135° C.

22. The adhesive composition of claim 16, wherein the one or more paraffinic hydrocarbons formed through dimerization of one or more C₁₈₊ LAOs and subsequent reduction have a kinematic viscosity (ASTM D-445) of about 4 cSt to about 8 cSt at 135° C.

23. The adhesive composition of claim 16, wherein the styrenic block copolymer comprises about 40 wt. % or less of the adhesive composition.
